(19) United States
(12) Patent Application Publication
(10) Pub. No.: US 2023/0240314 A1
(43) Pub. Date: Aug. 3, 2023

(54) ELECTROSTATIC SPRAY DRIED ACTIVE COMPUND POWDERS AND PRODUCTION METHOD THEREOF

(71) Applicant: Spraying Systems Co., Wheaton, IL (US)

(72) Inventors: Bogdan Zisu, Truganina (AU); AKM MASUM, Truganina (AU); Bao Loc Pham, Truganina (AU); Michel Thenin, Aurora, IL (US); Audrey Maudhuit, Treillieres (FR); Elodie Beaupeux, Treillieres (FR); Thomas Elliot Ackerman, Francestown, NH (US); Jason Tyler Rusch, Holus, NH (US); Lyndon John Wee Sit, Hudson, NH (US)

(21) Appl. No.: 18/129,355

(22) Filed: Mar. 31, 2023

Related U.S. Application Data
(63) Continuation-in-part of application No. PCT/US2022/054149, filed on Dec. 28, 2022.
(60) Provisional application No. 63/325,709, filed on Mar. 31, 2022.
(60) Provisional application No. 63/296,083, filed on Jan. 3, 2022.

(51) Int. Cl. A23D 7/04; A23L 27/00; A23L 27/12; A23L 3/46; A23D 7/005; A23L 29/30; A23L 29/10

(52) U.S. Cl. CPC A23D 7/04; A23L 27/72; A23L 27/12; A23L 3/46; A23D 7/0053; A23L 29/35; A23L 29/10

(57) ABSTRACT

Provided is a method of providing an active compound powder comprising electrostatic spray drying a formulation comprising at least one active compound, an encapsulating agent, and optionally an excipient at an inlet temperature of 150° C. or below and an exhaust temperature of 100° C. or below, wherein electrical charge is applied externally to droplets of active compound formulation feedstock liquid.

### CROSS-REFERENCE TO RELATED APPLICATIONS

This application is a continuation-in-part of copending International Patent Application PCT/US2022/054149, filed Dec. 28, 2022, which claims the benefit of U.S. Provisional Patent Application No. 63/296,083, filed Jan. 3, 2022, each of which is incorporated by reference in its entirety. This patent application also claims the benefit of U.S. Provisional Patent Application No. 63/325,709, filed Mar. 31, 2022, which is incorporated by reference in its entirety.

### BACKGROUND OF THE INVENTION

Encapsulated active compound powders have extensive use across a variety of industries, including food, beverages, cosmetics, and nutraceuticals. The encapsulation provides a barrier against, for example, oxygen, light, and free radicals (Desai et al., Journal of Microencapsulation, 22(2), 179-192 (2005)).

Active compound powders, for example oil powders, typically are produced using a spray drying system. However, such systems require high inlet and outlet temperatures, which can risk degrading the active compound or other components of the powder (Anwar et al., Journal of Food Engineering, 105, 367-378 (2011)). Thus, there remains a need to effectively provide an active compound powder that is shelf stable, has improved loading capacity, and/or improved encapsulation efficiency.

### BRIEF SUMMARY OF THE INVENTION

The invention provides a method of providing an active compound powder comprising electrostatic spray drying a formulation comprising at least one active compound, an encapsulating agent, and optionally an excipient, at an inlet temperature of 150° C. or below and an exhaust temperature of 100° C. or below, wherein electrical charge is applied externally to droplets of active compound formulation feedstock liquid [claim 1].

The invention also provides a method of providing an oil emulsion powder comprising electrostatic spray drying an emulsion comprising at least one oil, an encapsulating agent, and optionally an emulsifier at an inlet temperature of 150° C. or below and an exhaust temperature of 100° C. or below, wherein electrical charge is applied externally to droplets of oil emulsion feedstock liquid [claim 2].

### BRIEF DESCRIPTION OF THE SEVERAL VIEWS OF THE DRAWINGS

FIG. 1 is a vertical section of an illustrated spray drying system for processing an active compound containing-formulation into powder form according to an embodiment of the invention.

FIG. 2 is an enlarged vertical section of the electrostatic spray nozzle assembly of the illustrated spray drying system.

FIG. 3A is a first cross-section view of an electrostatic spray nozzle assembly in accordance with an illustrative example;

FIG. 3B is a second cross-section view of an electrostatic spray nozzle assembly in accordance with an illustrative example;

FIG. 4 is a detail cross-section view of nozzle head section, including an induction ring, of the electrostatic spray nozzle assembly depicted in FIGS. 3A and 3B;

FIG. 5 is an exploded perspective view of the electrostatic spray nozzle assembly depicted in FIGS. 3A and 3B;

FIG. 6 shows the scanning electron micro (SEM) images of 20%, 50%, and 80% (w/w) vegetable oil load powders encapsulated by electrostatic spray dried (ESD) and spray dried (SD) at 5,000× magnification.

FIGS. 7A and 7B are SEM images of 50% and 80% (w/w) ESD powders comprising either coconut oil and medium-chain-triglycerides (MCT) from coconut (FIG. 4A) or flaxseed oil and olive oil (FIG. 4B), each at 5,000× magnification.

FIG. 8 shows the SEM images of oil encapsulated powders containing 50% and 80% (w/w) fish oil and ghee at 5,000× magnification.

FIG. 9 shows the SEM images of oil encapsulated powders containing 50% (w/w) of either orange oil or mint oil, each at 5,000× magnification.

FIG. 10 shows the bacteria counts (log cfu/g, at 1% starter culture addition) for S. thermophilus (ST) and L. bulgaricus (LB) at day 0 and after storage at 4° C. for 90 days.

FIG. 11 shows the SEM images of encapsulated oil-bacteria powders at 10,000× magnification.

FIG. 12 shows the SEM images of 40% oil load DHA oil powders prepared by conventional spray drying (CSD) and electrostatic spray drying (ESD) with different encapsulants: (i) maltodextrin and casein, (ii) maltodextrin and methylcellulose, and (iii) maltodextrin and saponin.

FIG. 13 shows the relationship between percentage of viable bacterial cells in a dried powder versus time (in days), after drying with: an electrostatic spray dryer with an internal negative charge system (Run 001), an electrostatic spray dryer with an external positive charge system (Run 032), and conventional freeze drying.

While the invention is susceptible of various modifications and alternatives, certain illustrative embodiments will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

The present invention is predicated, at least in part, on the surprising discovery that active compound powders that are spray dried using a traditional high heat spray drying system compared to a low heat, electrostatic spray system are limited in their loading capacity and/or encapsulation efficiency. In accordance with this discovery, the invention provides a method of providing an active compound powder comprising electrostatic spray drying a formulation comprising at least one active compound, an encapsulating agent, and optionally an excipient, at an inlet temperature of 150° C. or below and an exhaust temperature of 100° C. or below. The produced active compound powder has at least one benefit over a corresponding active compound powder produce by spray drying, such as being more shelf stable, improved loading capacity, and/or improved encapsulation efficiency, compared to a comparable active compound powder prepared using spray drying.

The invention also provides a method of providing an oil emulsion powder comprising electrostatic spray drying an emulsion comprising at least one oil, an encapsulating agent, and optionally an emulsifier at an inlet temperature of 150° C. or below and an exhaust temperature of 100° C. or below.

In the method, the inlet temperature is any suitable temperature that provides an active compound powder with the features described herein. Typically, the inlet temperature is 150° C. or below (e.g., about 140° C. or below, about 135° C. or below, about 130° C. or below, about 125° C. or below, about 120° C. or below, about 115° C. or below, about 110° C. or below, about 105° C. or below, about 100° C. or below, about 95° C. or below, or about 90° C. or below). In some embodiments, the inlet temperature is about 140° C. or below, about 100° C. or below, about 150° C., about 140° C., or about 90° C. In comparison, conventional spray drying systems have a much higher inlet temperature, typically about 140° C. or higher, e.g., 180-250° C.

In the method, the outlet temperature is any suitable temperature that provides an active compound powder with the features described herein. Typically, the outlet temperature is about 80° C. or below (e.g., about 75° C. or below, about 70° C. or below, about 65° C. or below, about 60° C. or below, about 55° C. or below, about 50° C. or below, about 45° C. or below, about 40° C. or below, about 35° C. or below). In some embodiments, the outlet temperature is about 60° C. or below, about 50° C. or below, about 60° C., about 50° C., or about 35° C. In comparison, conventional spray drying systems have outlet temperatures that are above 60° C., typically about 95° C.

The atomizing temperature of the electrostatic spray drying system also is relatively low, such as about 100° C. or below (e.g., about 95° C. or below, about 90° C. or below, about 85° C. or below, about 80° C. or below, about 75° C. or below, about 70° C. or below, about 65° C. or below, about 60° C. or below, about 55° C. or below, about 50° C. or below, about 45° C. or below, about 40° C. or below, about 35° C. or below, or about 30° C. or below).

The electrostatic spray drying process applies a voltage to the spray droplets, which typically is about 0.1 kV or more (e.g., about 0.5 kV or more, about 1 kV or more, about 2 kV or more, about 4 kV or more, about 5 kV or more, about 7 kV or more, about 9 kV or more, about 12 kV or more, or about 15 kV or more). The upper limit of the applied voltage typically is 30 kV and in some instances, the upper limit is 20 kV or more preferably 15 kV. Any two of the foregoing endpoints can be used to define a close-ended range, or a single endpoint can be used to define an open-ended range. In the drying process, the applied voltage can be either continuous or modulated between two or more different voltages, known as Pulsed Width Modulation (PWM). Any two or more applied voltages ranging between 0.1-30 kV (e.g., 0.5 kV and 1 kV, 1 kV and 5 kV, 1 kV and 10 kV, 5 kV and 15 kV) can be used for PWM to provide a desired effect, such as a particular agglomerate size. In some embodiments of the method, the applied voltage is continuous. In other embodiments of the method, the applied voltage is modulated between two or more different voltages, e.g., alternating between 1 kV and 10 kV.

Alternatively, or in addition, to PWM, the charge (positive or negative) of the applied voltage can be altered, as necessary. Without wishing to be bound by any theory, it is believed that altering the electrostatic charge can change the surface composition of the particle, the agglomeration properties and/or other physical properties of the particles produced. For example, an applied negative charge will allow more conductive compounds to move towards the surface of the particle and non-conductive compounds will remain near the core of the particle. Accordingly, a negative electrostatic charge typically is applied in the electrostatic spray dry process when the charge is applied to the fluid internally with respect to the spray nozzle assembly disclosed herein. Alternatively, a positive electrostatic charge typically is applied in the electrostatic spray dry process when the charge is applied to the fluid externally with respect to the spray nozzle assembly disclosed herein. In some embodiments, alternating the charge of the applied voltage is used when preparing an oil powder.

The oil to be used in the method is any suitable oil that can be subjected to the electrostatic spray dry process. In some aspects, the at least one oil is plant or animal in origin. In some aspects, the oil is an edible oil. The oil can be provided by any source, including purchased commercially or extracted from a suitable plant (including a leaf, stem, root, nut, or seed) or animal source. Extraction can be by any suitable method, such as chemical solvent extraction and/or pressing.

Examples of the oil include vegetable oil, vegetable shortening, castor oil, rice brain oil, olive oil, canola oil, corn oil, palm oil, coconut oil, flaxseed oil, hempseed oil, rapeseed oil, linseed oil, grapeseed oil, rosehip seed oil, pomegranate seed oil, watermelon seed oil, seabuckthorn berry oil, camellia seed oil (tea oil), cranberry seed oil, hemp seed oil, borage seed oil, evening primrose oil, argan oil, jojoba oil, marula oil, carrot oil, sesame seed oil, sunflower oil, shea nut oil, soybean oil, peanut oil, walnut oil, almond oil, hazelnut oil, kukui nut oil, pecan oil, macadamia nut oil, meadowfoam oil, avocado oil, apricot kernel oil, an essential oil, silicone oil, fish oil, cocoa butter, shea butter, butter, ghee, medium chain triglycercides (MCT), and any combination thereof. Examples of an essential oil include, for example, aniseed oil, basil oil, bay oil, bergamot oil, cinnamon oil, clove oil, lavender oil, eucalyptus oil, lavender oil, ginger oil, geranium oil, rose oil, blue tansy oil, tea tree oil, moringa oil, lemon balm essential oil, lemongrass oil, thyme oil, rosemary oil, mint oil, lemon oil, orange oil, grapefruit oil, and fennel oil.

The encapsulating agent is any agent capable of encapsulating the active compound. In a preferred aspect of the invention, the encapsulating agent is a carbohydrate, a lipid, a protein, ascorbic acid, or a combination thereof.

In an aspect, the carbohydrate can be, e.g., maltodextrin, sucrose, dextrose, glucose, lactose, trehalose, amylase, cyclodextrin, dextrin, galactomannan, pectin, starch (e.g., corn starch, waxy maize starch, native tapioca starch, pea starch), modified food starch (e.g., modified tapioca starch, OSA (octenyl succinic anhydride) modified starch), inulin, gum Arabic, guar gum, gellan gum, mesquite gum, xanthan gum, alginate, chitosan, shellac, carboxymethylcellulose, or a combination thereof. Maltodextrins are usually classified by their dextrose equivalent value (DE) that range from 1 to 20. Maltodextrins with DE values of 4, 6, 10, 12, 15, 19, 20, 25, 30, and 42 are commercially available. Sources of maltodextrin include, e.g., maize, tapioca, and rice.

In an aspect, the lipid can be, e.g., a fatty acid or an ester thereof, a fatty alcohol or an ester thereof, a triglyceride, a phospholipid, a glycolipid, an aminolipid, a lipopeptide, partial acylglycerol, or a combination thereof. Examples of a suitable lipid include, e.g., carnauba wax, candelilla wax, beeswax, solid paraffin, rice bran wax, hydrogenated soybean oil, hydrogenated palm oil, palmitic acid, stearic acid, behenic acid, lauric acid, glyceryl tripalmitate glyceryl trimyristate, glyceryl trilaurate, cetyl alcohol, lauryl alcohol, stearyl alcohol, oleyl alcohol, and lecithin.

In an aspect, the protein can be protein from a plant source or an animal source (e.g., milk). Examples of proteins include, e.g., casein, a caseinate (e.g., sodium caseinate, calcium caseinate, calcium phosphate caseinate), gelatin, casein, soy protein, wheat protein, whey protein, rice protein, pea protein, cocoa shell protein, or a combination thereof.

In an aspect of the method, the processing conditions provide an emulsion between the at least one oil and encapsulating agent. In another aspect, the emulsion comprises an emulsifier. The emulsifier is any suitable surfactant that enables the production of an emulsified powder between the oil and the encapsulating agent. One or more than one (e.g., 2, 3, 4, etc.) emulsifiers can be used in the composition. In some aspects, the emulsifier is at least one selected from casein, a caseinate (e.g., sodium caseinate, calcium caseinate, calcium phosphate caseinate), lecithin, saponin (e.g., quilaja, glycyrrhizic acid), carrageenan, gum Arabic (GA), xanthan, whey protein isolate (WPI), whey protein concentrate (WPC), stearate, glyceryl monostearate, sucrose ester, monopropylene glycol, propylene glycol ester of fatty acid, polyglycerol esters of fatty acid, a mono- and diglycerol, mono- and diglycerides of fatty acids (e.g., citric acid ester of monoglyceride (CAEM), saturated distilled monoglyceride (SDM), polyglycerol fatty acid ester (PGFE), succinylated monoglyceride (SMG), lecithin (LC)), distilled monoglyceride, polyglycerol polyricinoleate, polysorbate 80, a sorbitan ester (e.g., polyoxyethylene(20) sorbitan monooleate, polyoxyethylene(20) sorbitan monostearate, polyoxyethylene(20) sorbitan monopalmitate, polyoxyethylene(20) sorbitan monolaurate, sorbitan monooleate, sorbitan tristearate, sorbitan monopalmitate), a lactylated ester (e.g., stearoyl lactylate), an ethoxylated ester, a succinated ester (e.g., sodium starch octenyl succinate), a fruit acid ester, carboxymethyl cellulose, and a combination thereof. In a preferred embodiment, the emulsion comprises at least one emulsifier.

In an aspect of the method, the formulation comprises at least one active compound that is part of the powder product. One active compound or more than one active compound (e.g., 2, 3, 4, 5, etc.) can be used. Typical active compounds include, e.g., an antioxidant, a vitamin, a bacterium, an omega oil, an essential oil, a flavoring agent, a pigment, a dye, and a combination thereof. In aspects of the invention, when the active compound is an oil the optional excipient is an emulsifier. In aspects of the invention, when the active compound is other than an oil the optional excipient is an oil.

An antioxidant can be used to inhibit oxidation and help stabilize the active compound, particularly an oil. Suitable antioxidants include, for example, butylated hydroxyanisole (BHA), butylated hydroxytoluene (BHT), propyl gallate (PG), tert-butyl hydroquinone (TBHQ), n-carotene, ascorbic acid, tocopherol, tea extract, rosemary extract, sage extract, thyme extract, alkannin, shikonin, ascorbyl palmitate, and a flavonoid (e.g., catechin, apicatechins, epicatechin gallate, epigallocatechin, and epigallocatechin gallate).

Vitamins include, for example, vitamin A, B, C, D, E, and K, including the vitamers of each thereof.

The bacterium includes, for example, a starter culture, a probiotic, and a combination thereof. The starter culture can be, for example, from the genus lactobacillus, streptococcus, and leuconostoc. Specific examples of a starter culture include, e.g., L. bulgaricus, L. lactis, L. acidophilus, L. helveticus, L. casei, L. plantarum, L. rhamnosus, Leuconostoc citrovorum, Leuconostoc dextranicum, S. lactis, S. cremoris, S. diacetylactis, S. durans, S. faecalis, S. thermophilus, propionic bacterium shermanii, and combinations thereof. Suitable probiotics include those from the genus bifidobacteria, lactobacillus, and saccharomyces, preferably bifidobacteria or lactobacillus. Specific examples of probiotic include, e.g., B. animalis, B. breve, B. lactis, B. longum, L. acidophilus, L. reuteri, S. bourladii, and combinations thereof.

The omega oil, also known as an omega-3 oil, is a polyunsaturated fatty acid with a double bond three atoms away from the terminal methyl group. Examples include, eicosapentaenoic acid (EPA), docosahexaenoic acid (DHA), α-linolenic acid (ALA), and a combination thereof.

The essential oil as an active compound is as described herein.

The flavoring agent can be in the form of an oil, a non-aqueous solution, or an emulsion. The flavoring agent can be natural or synthetic. Suitable examples include, e.g., limonene, fenchone, vanillin, thymol, menthol, isoamyl acetate, benzaldehyde, ethyl propionate, ethyl butyrate, methyl anthranilate, methyl salicylate, ethyl decadienoate, allyl hexanoate, ethyl maltol, 2,4-dithiapentance, fumaric acid, acetic acid, ascorbic acid, citric acid, lactic acid, malic acid, phosphoric acid, tartaric acid, citral, massoia lactone, acetoin, manzanate, cinnamaldehyde, a glutamate (e.g., mono- and/or disodium glutamate), a glycine salt, a guanylic acid salt, an inosinic acid salt, and a 5′-ribonucleotide salt.

The pigment or dye can be natural or synthetic and include, for example, a mineral, a clay, charcoal, carbon black, ultramarine, ultramarine green shade, Tyrian red, Indian yellow, a cadmium-based pigment (e.g., cadmium yellow, cadmium ted, cadmium green, cadmium orange), a chromium-based pigment (e.g., chrome yellow, chrome green), a cobalt-based pigment (e.g., cobalt violet, cobalt blue, cerulean blue, aureolin), a copper-based pigment (e.g., azurite, Han purple, Han blue, an Egyptian blue, malachite, Paris green, phthalocyanine blue BN, phthalocyanine Green G, verdigris), iron oxide-based pigment (e.g., sanguine, caput mortuum, oxide red, red ochre, yellow ochre, Venetian red, Prussian blue), a lead-based pigment (e.g., white lead, red lead, cremnitz white, Naples yellow), a manganese-based pigment (e.g., manganese violet, YInMn blue), a titanium-based pigment (e.g., titanium yellow, titanium beige, titanium white, titanium black), a zinc-based pigment (e.g., zinc white, zinc ferrite, zinc yellow), a marine based pigment (e.g., chlorophyll a, b, and c, ß-carotene, phycocyanin, xanthophyll, phycoerythrin), aluminum powder, vermillion, an aniline dye (e.g., mauveine, aniline yellow), an azo dye (e.g., C.I. Direct Black 171, sunset yellow, tartrazine, azorubine, ponceau, amaranth, allura red), an acid dye (e.g., Indian ink, congo red, nigrosoine), a naphthol (an azoic) dye, a nitro dye (e.g., maritus yellow), an anthraquinone dye (e.g., C.I. Reactive Blue 19, indanthrone, alizarin, 1-aminoanthraquinone), a sulfur dye (e.g., indophenol, sulfur black, sulfur red 7), turmeric, and combinations thereof.

In an aspect of the invention, the oil emulsion powder produced by the method has a lower amount of surface free fat, i.e., oil, compared to a spray dried powder of the same oil emulsion. For example, the oil powder product can have 40% surface free fat or less (e.g., 37% or less, 35% or less, 30% or less, 25% or less, 20% or less, 10% or less, 8% or less, 6% or less, 5% or less, 4% or less, 3% or less, 2% or less, 1% or less, 0.5% or less, or 0.2% or less).

The percentage of surface free fat or oil can be determined as follows:
put 3 g of powder in a beaker,
add 30 mL of hexane,
stir for 2 minutes,
filter through a Whatman filter paper n° 1 into a beaker of known weight,
take the weight of the beaker after complete solvent evaporation, about 48 hours.

$$\% surface oil = \frac{beaker weight after filtration - beaker weight before filtration}{theoritical weight of oil in powder}$$

In an aspect of the invention, the oil emulsion powder has any suitable oil load (e.g., about 1-90%). For example, the oil load can be about 1% or more (e.g., about 5% or more, about 10% or more, about 15% or more, about 20% or more, about 25% or more, about 30% or more, about 35% or more, about 40% or more, about 45% or more, about 50% or more, about 55% or more, about 60% or more, about 65% or more, about 70% or more, about 75% or more, about 80% or more, or about 85% or more). The upper limit of the oil load is typically about 90% or less (e.g., about 85% or less, about 80% or less, about 75% or less, about 70% or less, about 65% or less, about 60% or less, about 55% or less, about 50% or less, about 45% or less, about 40% or less, about 35% or less, about 30% or less, about 25% or less, about 20% or less, about 15% or less, or about 10% or less). Any two of the foregoing endpoints can be used to define a close-ended range, or a single endpoint can be used to define an open-ended range. In an aspect, the oil powder produced by the claimed method has a higher oil load (e.g., 20% or more, 50% or more, 60% or more, 70% or more, or 80% or more, about 90%).

In an aspect of the invention, the active compound formulated powder has an encapsulation efficiency of 50% or more (e.g., 55% or more, 60% or more, 65% or more, 70% or more, 75% or more, 80% or more, 85% or more, 90% or more, 92% or more, 95% or more, 96% or more, 97% or more, 98% or more, and 99% or more).

Active encapsulation efficiency can be determined as follows:
mix 2.5 g of powder with 18 mL of water in a beaker,
put the beaker in an ultrasound bath for 20 min,
transfer the beaker solution to separating funnel,
add 10 mL of chloroform and 20 mL of methanol,
shake by inversion 50 times,
add 10 mL of chloroform,
shake the separating funnel for 2 minutes,
keep static for 2 hours,
filter the upper phase through a Whatman filter paper n° 1 into a beaker of known weight,
after complete solvent evaporation, weigh the beaker.

$$Encapsulation Efficiency = \frac{beaker weight after filtration - beaker weight before filtration}{theoritical weight of oil in powder}$$

In an aspect of the invention, the method provides an improved oil load and encapsulation efficiency compared to a spray dried powder of the same oil emulsion. In particular, the oil load of the produced oil powder can range from 1-60% in combination with an encapsulation efficiency that ranges from 90-99%. In another aspect of the invention, the oil load can range from 61-90% in combination with an encapsulation efficiency that ranges from 55-90%.

The active compound powder product has a low moisture content, typically about 5% or less (e.g., about 4.5% or less, about 4% or less, about 3.5% or less, about 3% or less, about 2.5% or less, about 2% or less), preferably in combination with a low water activity (e.g., about 0.3 or less, including about 0.28 or less, about 0.25 or less, about 0.2 or less, about 0.18 or less, about 0.15 or less, or about 0.1 or less). In an aspect of the method, the active compound powder product has a moisture content of about 4% or less or about 3% or less.

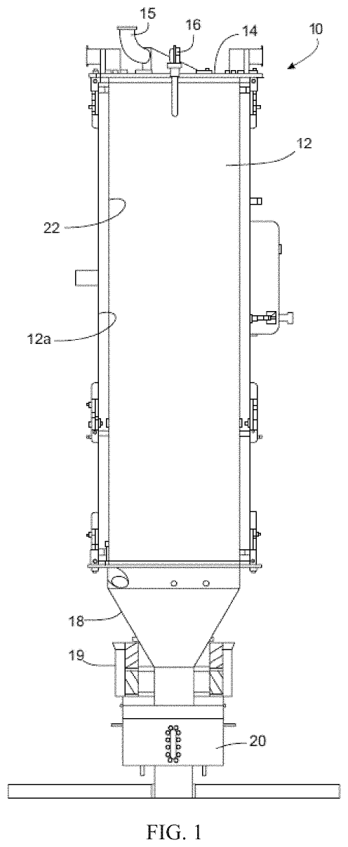

Referring now more clearly to the drawings, FIG. 1 is an illustrated spray drying system 10 for processing an active compound encapsulation formulation into powder form according to the invention. A basic construction and operation of the illustrated spray drying system 10 is similar to that disclosed in U.S. Pat. No. 10,286,411, assigned to the same assignee as the present application, the disclosure of which is incorporated herein by reference.

The spray drying system 10 in this case includes a processing tower 11 comprising a drying chamber 12 in the form of an upstanding cylindrical structure, a top closure arrangement in the form of a cover or lid 14 for the drying chamber 12 having a heating air inlet 15 and a liquid spray nozzle assembly 16, and a bottom closure arrangement in the form of a powder collection cone 18 supported at the bottom of the drying chamber 12, a filter element housing 19 through which the powder collection cone 18 extends having a heating air exhaust outlet, and a bottom powder collection chamber 21.

The illustrated drying chamber 12 has a “replaceable internal non-metallic” insulating liner 22 disposed in concentric spaced relation to the inside wall surface 12a of the drying chamber 12 into which electrostatically charged liquid spray particles from the spray nozzle assembly 16 are discharged. The liner 100 has a diameter d less than the internal diameter dl of the drying chamber 12 so as to provide an insulating air spacing 101 with the inner wall surface 12a of the drying chamber 12. The liner 100 preferably is non-structural being made of a non-permeable flexible plastic material.

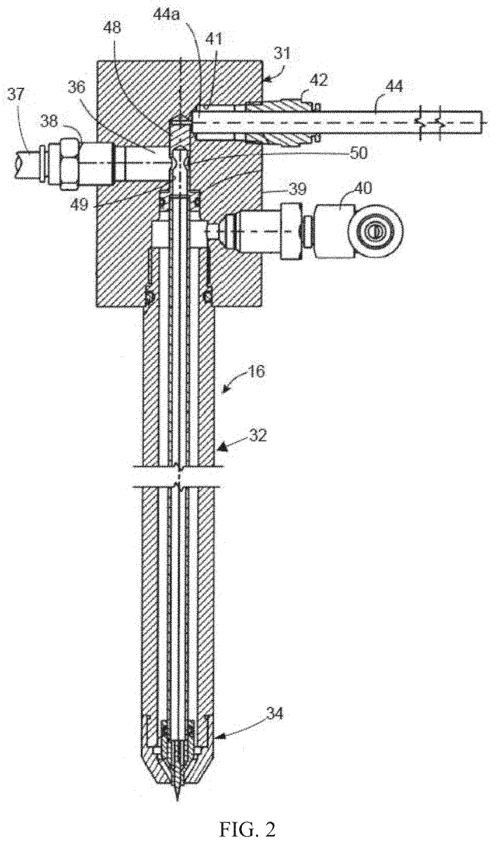

The spray nozzle assembly 16, as best depicted in FIG. 2, is a pressurized air assisted electrostatic spray nozzle assembly for directing a spray of electrostatically charged particles into the dryer chamber 12 for quick and efficient drying of an active compound encapsulated formulation into powder form. The illustrated spray nozzle assembly 16, includes a nozzle supporting head 31, an elongated nozzle barrel or body 32 extending downstream from the head 31, and a discharge spray tip assembly 34 at a downstream end of the elongated nozzle body 32. The head 31 in this case is made of plastic or other non-conductive material and formed with a radial liquid inlet passage 36 that receives and communicates with a liquid inlet fitting 38 for coupling to a supply line 37 that communicates with a supply of an active compound powder product to be spray dried.

The nozzle supporting head 31 in this case further is formed with a radial pressurized air atomizing inlet passage 39 downstream of said liquid inlet passage 36 that receives and communicates with an air inlet fitting 40 coupled to a suitable pressurized gas supply. The head 31 also has a radial passage 41 upstream of the liquid inlet passage 36 that receives a fitting 42 for securing a high voltage cable 44 connected to a high voltage source and having an end 44a extending into the passage 41 in abutting electrically contacting relation to an electrode 48 axially supported within the head 31 and extending downstream of the liquid inlet passage 36.

For enabling liquid passage through the head 31, the electrode 48 is formed with an internal axial passage 49 communicating with the liquid inlet passage 36 and extending downstream though the electrode 48. The electrode 48 is formed with a plurality of radial passages 50 communicating between the liquid inlet passage 36 and the internal axial passage 49.

The elongated body 32 is in the form of an outer cylindrical body member 55 made of plastic or other suitable nonconductive material, having an upstream end 55a threadably engaged within a threaded bore of the head 31. The liquid feed tube 58 is disposed in electrical contacting relation with the electrode 48 for efficiently electrically charging liquid throughout its passage from the head 31 and through elongated nozzle body member 32 to the discharge spray tip assembly 34, which in this case is similar to that disclosed in U.S. Pat. No. 10,286,411.

Thus, with the spray nozzle assembly 16 illustrated in FIG. 2, fluid is charged internally with respect to the spray nozzle assembly 16. More specifically, the fluid is charged as it passes through the liquid feed tube 58 prior to the fluid exiting the spray nozzle assembly 16.

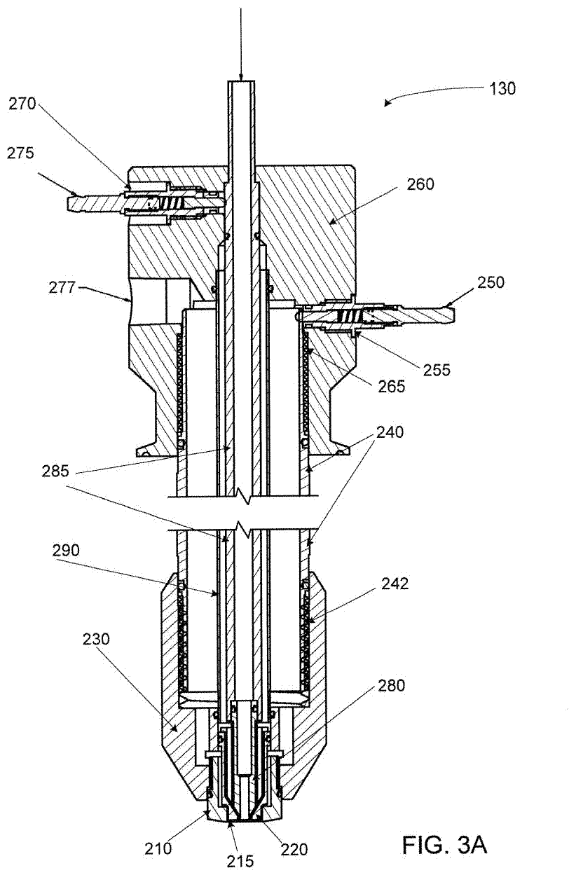

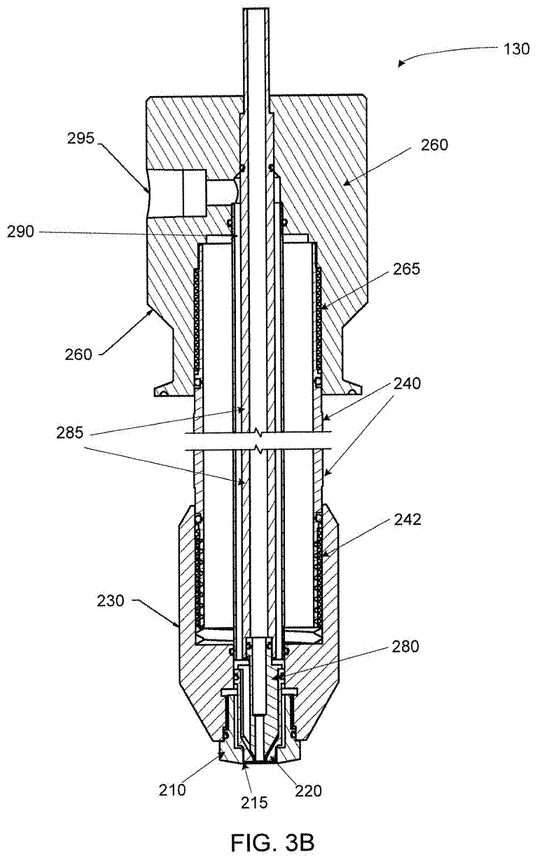

A further embodiment of a spray nozzle assembly 130 for use in the spraying drying system 10 of FIG. 1 is shown in FIGS. 3-5. By way of a first specific example, the spray nozzle 130 is specially configured nozzle assembly that, in operation, exhibits certain electrical properties facilitating generation of a continuous flow of electrostatically charged spray droplets. Turning to FIG. 3A, an exemplary electrostatic spray nozzle arrangement is illustratively depicted where electrostatic charging of spray droplets is achieved by an electrical circuit arrangement including an induction ring 210 provided in the form of an electrically conductive metal retaining cap positioned at an exit aperture of the spray nozzle 130. An opening 215 of the induction ring 210 is sufficiently wide to avoid, with the aid of a purging gas stream, excessive buildup of the active compound formulation emitted from an opening of an atomizing gas cap 220 that passes in droplet form through the opening 215. By way of example, the opening 215 has an inner diameter on the order of less than 1 inch for an applied electrical field having a voltage of 3,000 to 4,000 volts (3-4 kilovolts). More particularly, the opening 215 has a diameter of about 0.7 inches. However, in accordance with various applications involving spray drying active compound formulations, the diameter of the opening 215 and/or the applied voltage (electrical field potential between the induction ring 215 and active compound formulations exiting the nozzle) are modified in accordance with spray pattern (wide/narrow spray field), nozzle aperture position (linear displacement along path of spray field) in relation to the opening 215 of the induction ring 210. In the illustrative example, the atomizing gas cap 220 is a non-conductive insulating material (e.g., a rigid plastic material).

A first conductive path is provided for generating an electrostatic field at the opening 215 of the induction ring 210 to electrostatically charge droplets of active compound formulation emitted from the atomizing gas cap. To that end, the induction ring 210 physically (by complementary screw threating) and conductively engages an electrically conductive surface of a nozzle head 230. The first conductive path is further provided by a further physical and conductive engagement of the nozzle head 230 with a purge gas tube 240. By way of example, the nozzle head 230 and the purge gas tube 240 are physically and conductively engaged by complementary screw thread surfaces at 242. The purge gas tube 240 is also provided with an electrically conductive surface providing an electrically conductive path from the nozzle head 230 to an induction field (high voltage) electrode 250 from a high voltage field signal source (not shown).

In an illustrative example, outer surfaces of electrically conductive components, (e.g., the induction ring 210) are coated with an electrically insulating layer to reduce the possibility of arcing within the spraying environment. As such, only the inner surface (or portion thereof) of the exposed surfaces of the induction ring 210 (as opposed to a non-exposed threaded surface of the induction ring 210 that is also a conductive surface) is a conductive surface. Such electrically insulating layer is provided by, for example, a polytetrafluoroethylene (PTFE) coating.

In yet a further illustrative example, all exposed surfaces of electrically conductive components—even the inner exposed surface of the induction ring 210—are coated with a strong dielectric material (e.g. PTFE) to provide an electrical insulating barrier between the high (magnitude) voltage of the induction ring 210 and low (magnitude) voltage of the active compound formulation as well as any potentially ground connection sources to which the feed stock comes into contact prior to exiting the spray nozzle. Such arrangement facilitates preventing, minimizing any current flow from the induction ring during operation of the illustrative electrostatic spray drying system.

A second conductive path is provided for establishing a complementary electrical (e.g. ground) path from conductive feed lines through which the active compound formulation passes from, for example, an active compound formulation feed tank to the atomizing gas cap 220. The second conductive path provides a source for inducing a charge (opposite the field potential generated at the opening 215) on the droplets passing from a fluid tip 280 having an electrically grounded conductive surface in contact with the active compound formulation through an electric field at the opening 215. The second conductive path continues at a physical and electrical connection between the fluid tip 280 and a fluid tube 285 that provides the feedstock to the fluid tip 280. Similarly to the outer surface of the induction ring, the outer surfaces of the fluid tip 280 and fluid tube 285 are coated with an electrically insulating layer (e.g., PTFE).

An atomizing gas tube 290 provides atomizing gas to the atomizing gas cap 220. The atomizing gas tube 290 is, by way of example made of a non-electrically conductive material (e.g. a rigid plastic, ceramic, etc.) that is configured to provide a sealed engagement with the atomizing gas cap 220. Alternatively, the atomizing gas tube 290 comprises a conductive material coated with an electrically insulating material. As such, the atomizing gas tube 290 and atomizing gas cap 220 provide an electrically insulating barrier between the first conductive path and the second conductive path described herein above. It is noted that such electrically insulating characteristic may alternatively be achieved by coating exposed surfaces with an insulating coating (e.g. PTFE).

As shown in FIG. 3A, a nozzle body 260 is physically configured with several receptacles/openings for maintaining physical/electrical engagement between components of the spray nozzle 130 illustratively depicted herein. In the illustrative example, the nozzle body 260 includes an induction field electrode receptacle 255 holding the induction field electrode 250 in electrically conductive engagement with the electrically conductive surface of the purge gas tube 240. The nozzle body 260 includes a ground electrode receptacle 270 holding an electrical ground electrode 275 in electrically conductive engagement with the electrically conductive surface of the fluid tube 285. An induction ring purge gas port 277 provides an opening for feeding a purge gas that flows through the purge gas tube 240 to the opening 215 in the induction ring 210. As further shown in FIG. 3B (a further cross sectional view rotated 90 degrees from the view depicted in FIG. 3A), the nozzle body 260 further includes an atomizing gas port 295 that provides an opening for feeding an atomizing gas to the atomizing gas tube 290.

As shown in FIG. 3A, the nozzle body 260 includes a cylindrical receptacle having a threaded surface at 265 to hold in place the purge gas tube 240 having a complementary threaded outer surface.

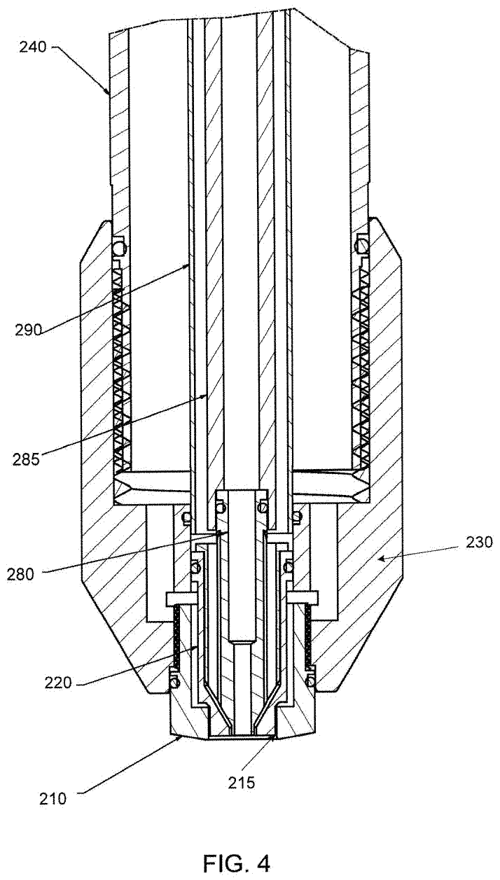

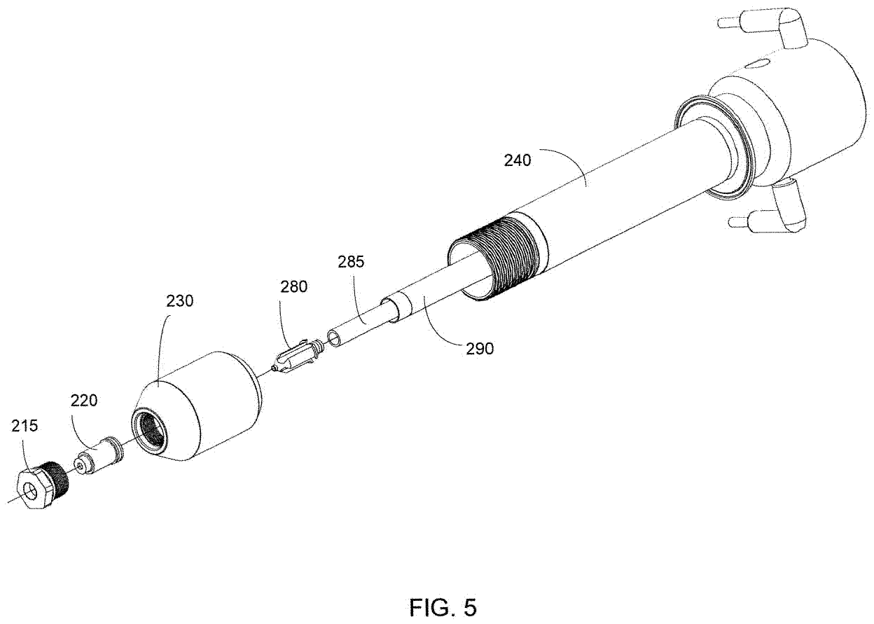

Turning to FIG. 4, an additional detailed view is provided of the nozzle head portion of the spray nozzle depicted in FIGS. 3A and 3B to enable a clearer view of the various physical relationships depicted in FIGS. 3A and 3B and the corresponding written description provided herein above. Additionally, FIG. 5 provides an exploded perspective view of the electrostatic spray nozzle assembly depicted in FIGS. 3A and 3B to provide additional visual details of the illustrative example of an electrostatic spray nozzle in accordance with the current disclosure.

Thus, in contrast to the spray nozzle assembly 16 of FIG. 2 in which the fluid is charged internally before exiting the spray nozzle, the spray nozzle assembly 130 of FIGS. 3-5 charges the fluid (via the induction ring 210) after it exits the spray nozzle assembly in droplet form. This external charge configuration can offer several advantages over the internal charge arrangement of FIG. 2 including the ability to use significantly lower voltages which can lead, among other things, to increased safety. Further, the external charge arrangement can have cost advantages by eliminating the need for special electrically insulated components along the liquid feed path.

As will become apparent, the electrostatic spray drying system 10 is operable for drying active compound powders into fine particles with improved characteristics over the prior art.

As used herein the term “about” typically refers to ±1% of a value, ±5% of a value, or ±10% of a value.

The invention is further illustrated by the following features.

(1) A method of providing an active compound powder comprising electrostatic spray drying a formulation comprising at least one active compound, an encapsulating agent, and optionally an excipient at an inlet temperature of 150° C. or below and an exhaust temperature of 100° C. or below, wherein electrical charge is applied externally to droplets of active compound formulation feedstock liquid.

(2) A method of providing an oil emulsion powder comprising electrostatic spray drying an emulsion comprising at least one oil, an encapsulating agent, and optionally an emulsifier at an inlet temperature of 150° C. or below and an exhaust temperature of 100° C. or below, wherein electrical charge is applied externally to droplets of oil emulsion feedstock liquid.

(3) The method of feature 1 or 2, wherein the atomizing temperature is about 100° C. or below.

(4) The method of one of features 1-3, wherein the applied voltage is about 0.1 kV or more.

(5) The method of any one of features 1-4, wherein the applied voltage is continuous.

(6) The method of any one of features 1-5, wherein the applied voltage is modulated between two or more different voltages.

(7) The method of any one of features 2-6, wherein the oil emulsion powder has lower amount of surface free fat compared to a spray dried powder of the same oil emulsion.

(8) The method of any one of features 2-7, wherein the oil emulsion powder has an encapsulation efficiency of 50% or more.

(9) The method of feature 8, wherein the oil load ranges from 1-60% and the encapsulation efficiency ranges from 90-99%.

(10) The method of feature 8, wherein the oil load ranges from 61-90% and the encapsulation efficiency ranges from 55-90%.

(11) The method of any one of features 1-10, wherein the at least one oil is plant or animal in origin.

(12) The method of feature 11, wherein the at least one oil is vegetable oil, vegetable shortening, castor oil, rice brain oil, olive oil, canola oil, corn oil, palm oil, coconut oil, flaxseed oil, hempseed oil, rapeseed oil, linseed oil, grapeseed oil, rosehip seed oil, pomegranate seed oil, watermelon seed oil, seabuckthorn berry oil, camellia seed oil (tea oil), cranberry seed oil, hemp seed oil, borage seed oil, evening primrose oil, argan oil, jojoba oil, marula oil, carrot oil, sesame seed oil, sunflower oil, shea nut oil, soybean oil, peanut oil, walnut oil, almond oil, hazelnut oil, kukui nut oil, pecan oil, macadamia nut oil, meadowfoam oil, avocado oil, apricot kernel oil, an essential oil, silicone oil, fish oil, cocoa butter, shea butter, butter, ghee, medium chain triglycercides (MCT), or any combination thereof.

(13) The method of any one of features 1-12, wherein the encapsulating agent is a carbohydrate, a lipid, a protein, ascorbic acid, or a combination thereof.

(14) The method of feature 13, wherein the carbohydrate is maltodextrin, sucrose, dextrose, glucose, lactose, trehalose, amylase, cyclodextrin, dextrin, galactomannan, pectin, starch, modified food starch, inulin, gum Arabic, guar gum, gellan gum, mesquite gum, xanthan gum, alginate, chitosan, shellac, carboxymethylcellulose, or a combination thereof.

(15) The method of feature of 13 or 14, wherein the lipid is a fatty acid or an ester thereof, a fatty alcohol or an ester thereof, a triglyceride, a phospholipid, a glycolipid, an aminolipid, a lipopeptide, partial acylglycerol, or a combination thereof.

(16) The method of any one of features 13-15, wherein the protein is casein, caseinate, gelatin, soy protein, wheat protein, whey protein, rice protein, pea protein, cocoa shell protein, or a combination thereof.

(17) The method of any one of features 2-16, wherein the emulsion comprises an emulsifier.

(18) The method of features 17, wherein the emulsifier is at least one selected from casein, caseinate, lecithin, saponin, carrageenan, gum Arabic, xanthan, whey protein isolate, stearate, glyceryl monostearate, sucrose ester, monopropylene glycol, propylene glycol ester of fatty acid, polyglycerol esters of fatty acid, a mono- and diglycerol, mono- and diglycerides of fatty acids, distilled monoglyceride, polyglycerol polyricinoleate, polysorbate 80, a sorbitan ester, a lactylated ester, an ethoxylated ester, a succinated ester, a fruit acid ester, carboxymethyl cellulose, and a combination thereof.

(19) The method of any one of features 2-18, wherein the emulsion further comprises at least one active compound.

(20) The method of feature 1 or 19, wherein the at least one active compound is an antioxidant, a vitamin, a bacterium, an omega oil, an essential oil, a flavoring agent, a pigment, a dye, or a combination thereof.

(21) The method of claim 20, wherein when the active compound is an oil the optional excipient is an emulsifier, and when the active compound is other than an oil the optional excipient is an oil.

The following examples further illustrate the invention but, of course, should not be construed as in any way limiting its scope.

### Example 1

This example demonstrates low temperature electrostatic spray drying of an oil powder product in an embodiment of the invention.

Oil emulsion powders were made by electrostatic spray drying (ESD) at inlet temperatures of 90° C., 140° C., and 150° C., however, the inlet drying temperature can be as low as 80° C. Atomizing temperature was generally maintained below 80° C. and the exhaust temperature below 60° C. In this example, the atomizing temperature was set to 35° C., 50° C., and 80° C. to obtain exhaust temperatures of 35° C., 50° C., and 60° C., respectively. Negative pulsed width modulation (PWM) alternating between 10 kV and 1 kV was used in these examples, however, electrostatic charge may be positive, and it may be as low as 0.1 kV and as high as 20 kV with or without PWM. Atomizing gas pressure may range from 30-552 kPa. For comparison, oil emulsion powders were also spray dried at 180° C. inlet and 90° C. exhaust by conventional high heat spray drying. The processing parameters are shown in Table 1.

TABLE 1

| | ESD | ESD | ESD | Spray Dried |
|---|---|---|---|---|
| Parameter | (90/35° C.) | (140/50° C.) | (150/60° C.) | (180/95° C.) |
| Inlet temp (° C.) | 90 | 140 | 150 | 180 |
| Outlet temp (° C.) | 35 | 50 | 60 | 95 |
| Atomizing gas | 210 | 210 | 210 | 100 |
| pressure (kPa) | | | | |
| PWM voltage | 10/1 | 10/1 | 10/1 | NA |
| (High/Low) (kV) | | | | |
| Charge | -ve | -ve | -ve | NA |

ESD = electrostatic spray dried

### Example 2

This example demonstrates low temperature electrostatic spray drying of a vegetable oil powder product in an embodiment of the invention.

Vegetable oil emulsions were formulated to contain 20% to 90% (w/w) vegetable oil, encapsulated with maltodextrin and stabilized with sodium caseinate. Oil emulsions were spray dried (SD) at 180° C. and electrostatic spray dried (ESD) with 10 kV PWM at 90° C. and 140° C. Table 2 shows the moisture content and water activity of the resulting vegetable oil powders. Moisture content was below 3% in all powders and water activity below 0.22.

TABLE 2

| | Moisture content | |
|---|---|---|
| | solids-non-fat | Water activity (a_{w}) |
| Powder | (% w/w ± sd) | (a_{w} ± sd) |
| ESD20% Oil_90/35 | 2.74 ± 0.72 | 0.1573 ± 0.0213 |
| ESD20% Oil_140/50 | 1.29 ± 0.02 | 0.0843 ± 0.0053 |
| ESD50% Oil_90/35 | 2.28 ± 0.51 | 0.1657 ± 0.0040 |
| ESD50% Oil_140/50 | 1.18 ± 0.06 | 0.0937 ± 0.0072 |
| ESD60% Oil_140/50 | 1.56 ± 0.44 | 0.1508 ± 0.0112 |
| ESD70% Oil_140/50 | 1.18 ± 0.16 | 0.1556 ± 0.0107 |
| ESD80% Oil_140/50 | 1.03 ± 0.18 | 0.1882 ± 0.0324 |
| ESD90% Oil_140/50 | 1.45 ± 0.07 | 0.2194 ± 0.0085 |
| SD20% Oil_180/95 | 0.51 ± 0.09 | 0.0969 ± 0.0021 |
| SD50% Oil_180/95 | 0.65 ± 0.10 | 0.1116 ± 0.0073 |
| SD80% Oil_180/95 | 1.03 ± 0.25 | 0.1924 ± 0.0085 |

sd = standard deviation
ESD = electrostatic spray dried
SD = spray dried
90/35, 140/50, 180/95 = inlet and outlet drying temperatures

Table 3 shows the oil load, surface free fat, encapsulation efficiency, and peroxide value of vegetable oil powders. The peroxide values (in all of the examples except Example 7) were measured soon after preparation of the powders using the spectrophotometric standard method of the International Dairy Federation (IDF) (see, e.g., Rahmani-Manglano et al., Foods, 9, 545, 21 pages (2020)). Alternative methods of measuring the peroxide value include, e.g., the titration method of the International Fragrance Association (IFRA) and American Oil Chemists' Society (AOCS) Official Method Cd 8b-90 (see also, e.g., Selim et al., Molecules, 26, 6109, 17 pages (2021) and Shantha et al., Journal of AOAC International, 77(2), 421-424 (1994)).

Electrostatic spray drying produced powders with greater encapsulation efficiency than spray drying at 20%, 50%, and 80% oil load. Overall, the encapsulation efficiency drops with increasing oil load. At 20% oil load, the encapsulation efficiency was greater than 99% in ESD powders and lower than 97% in spray dried powders. At 50% oil load, the encapsulation efficiency was more than 97% in ESD powders compared to less than 90% in spray dried powders. At 80% oil load, ESD powders had 73% encapsulation efficiency compared to 53% by spray drying.

Traditional high heat spray drying has been used to produce oil emulsion powders with up to 67% oil load with significantly lower encapsulation efficiency than the present inventive ESD method. See, e.g., Alpizar-Reyes et al., International Journal of Biological Macromolecules, 2020, 145, 207-215; Benito-Román et al., Heliyon, 2020, 6(4), e03615-e03615; da Silva James et al., Brazilian Journal of Development, 2019, 5 (7), 8082-95; and Domian et al., Journal of Food Engineering, 2014, 125(1), 34-43. Comparable encapsulation efficiency was reported in powders with lower oil loads of up to 22% (Benito-Román et al., 2020).

Without being bound by any theory, it is believed that the difference in encapsulation efficiency is due to the difference in surface free fat. Surface free fat is approximately three times lower in ESD powders at 20% and 50% oil load (<0.2% vs 0.6% at 20% oil; <1.5% vs 5% at 50% oil load). At 80% oil load the difference between ESD and SD is almost double (21.53% ESD vs 37.41% SD).

The peroxide value was low (below 1.8 meq O₂/kg oil) in all the powders.

TABLE 3

| | | | | Peroxide |
|---|---|---|---|---|
| | | Surface | Encapsulation | value |
| | Oil load | free fat | efficiency | (meq O₂/kg |
| Powder | (% ± sd) | (% ± sd) | (% ± sd) | oil ± sd) |
| ESD20% | 19.94 ± 0.18 | 0.19 ± 0.06 | 99.07 ± 0.33 | 1.40 ± 0.20 |
| Oil_90/35 | | | | |
| ESD20% | 20.42 ± 0.66 | 0.11 ± 0.03 | 99.46 ± 0.16 | 0.96 ± 0.09 |
| Oil_140/50 | | | | |
| ESD50% | 49.88 ± 0.11 | 1.15 ± 0.39 | 97.71 ± 0.77 | 1.71 ± 0.45 |
| Oil_90/35 | | | | |
| ESD50% | 50.04 ± 0.22 | 1.49 ± 0.01 | 97.03 ± 0.03 | 0.72 ± 0.16 |
| Oil_140/50 | | | | |
| ESD60% | 59.83 ± 0.13 | 5.09 ± 0.52 | 91.50 ± 0.88 | 0.93 ± 0.19 |
| Oil_140/50 | | | | |
| ESD70% | 69.69 ± 0.20 | 14.06 ± 0.35 | 79.83 ± 0.44 | 1.02 ± 0.18 |
| Oil_140/50 | | | | |
| ESD80% | 79.89 ± 0.10 | 21.53 ± 0.49 | 73.05 ± 0.59 | 0.88 ± 0.09 |
| Oil_140/50 | | | | |
| ESD90% | 89.55 ± 0.38 | 36.92 ± 1.08 | 58.77 ± 1.38 | 0.25 ± 0.05 |
| Oil_140/50 | | | | |
| SD20% | 19.93 ± 0.05 | 0.62 ± 0.20 | 96.89 ± 0.99 | 1.74 ± 0.18 |
| Oil_180/95 | | | | |
| SD50% | 49.89 ± 0.25 | 5.08 ± 0.45 | 89.83 ± 0.93 | 1.22 ± 0.10 |
| Oil_180/95 | | | | |
| SD80% | 79.65 ± 0.45 | 37.41 ± 1.80 | 53.03 ± 2.53 | 0.21 ± 0.02 |
| Oil_180/95 | | | | |

sd = standard deviation
ESD = electrostatic spray dried
SD = spray dried
meq = milliequivalent
90/35, 140/50, 180/95 = inlet and outlet drying temperatures

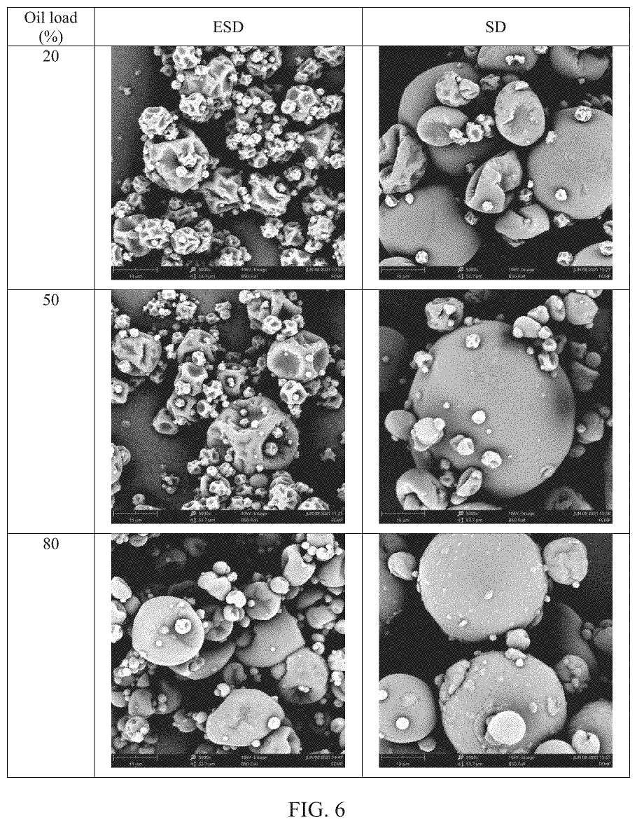

FIG. 6 shows the scanning electron micro (SEM) images of 20%, 50%, and 80% (w/w) vegetable oil load powders encapsulated by electrostatic spray dried (ESD) and spray dried (SD) at 5,000× magnification. Primary particles in SD powders were generally larger than ESD powders. At 20% and 50% oil load, there was little change in appearance, however, at 80% oil load, the physical appearance changed. In ESD powders, there was increased swelling of the primary particles, and SD powders exhibited significant particle fusion.

### Example 3

This example demonstrates low temperature electrostatic spray drying of a plant-based oil powder product in an embodiment of the invention.

Coconut oil, medium-chain-triglycerides (MCT) from coconut, flaxseed oil and olive oil emulsions were formulated to contain 50% and 80% (w/w) oil, encapsulated with maltodextrin and stabilized with sodium caseinate. Emulsions were then dried using electrostatic spray drying at temperatures of 90° C. inlet and 35° C. outlet.

Table 4 shows the moisture content and water activity of resulting powders. All the powders had a moisture content below 4% and a water activity below 0.28. Moisture and water activity were higher in powders with greater oil load.

TABLE 4

| | Moisture content solids-non-fat | Water activity (a_{w}) |
|---|---|---|
| Powder | (% w/w ± sd) | (a_{w} ± sd) |
| Coconut50% Oil | 1.44 ± 0.45 | 0.149 ± 0.029 |
| Coconut80% Oil | 3.13 ± 0.32 | 0.258 ± 0.002 |
| MCT50% Oil | 1.27 ± 0.10 | 0.179 ± 0.012 |
| MCT80% Oil | 1.80 ± 0.92 | 0.266 ± 0.022 |
| Flaxseed5 0% Oil | 1.46 ± 0.17 | 0.150 ± 0.007 |
| Flaxseed80% Oil | 2.13 ± 0.32 | 0.235 ± 0.017 |
| Olive50% Oil | 3.34 ± 0.57 | 0.268 ± 0.019 |
| Olive80% Oil | 3.43 ± 0.18 | 0.280 ± 0.006 |

sd = standard deviation

Table 5 shows the oil load, surface free fat, encapsulation efficiency and peroxide value of coconut oil, MCT, flaxseed oil, and olive oil powders. At 50% oil load the surface free fat was approximately 1-1.2% and this increased to 16-20% at 80% oil load in all powders. Encapsulation efficiency was >97% at 50% oil load and 74-79% in powders containing 80% oil.

The peroxide values were lowest (0.05-0.15 meq O₂/kg oil) in coconut oil powders irrespective of oil load presumably due to the high content of saturated fats (Hee et al., The Journal of Supercritical Fluids, 2017, 130, 118-124). Flaxseed and olive oils are rich in unsaturated fatty acids (Bakry et al., Comprehensive Reviews in Food Science and Food Safety, 2008, 15(1), 143-182; Koutsopoulos et al., Meat Science, 2008, 79(1), 188-197), and the peroxide value increased (1.19-1.68 meq O₂/kg oil).

TABLE 5

| | | | Encapsu- | Peroxide |
|---|---|---|---|---|
| | | Surface | lation | value |
| | Oil load | free fat | efficiency | (meq O₂/kg |
| Powder | (% ± sd) | (% ± sd) | (% ± sd) | oil ± sd) |
| Coconut50% Oil | 50.26 ± 0.28 | 1.20 ± 0.16 | 97.61 ± 0.32 | 0.11 ± 0.04 |
| Coconut80% Oil | 80.05 ± 0.15 | 18.06 ± 0.79 | 77.44 ± 1.03 | 0.05 ± 0.01 |
| MCT50% Oil | 50.34 ± 0.23 | 1.04 ± 0.18 | 97.93 ± 0.36 | 0.15 ± 0.02 |
| MCT80% Oil | 80.09 ± 0.23 | 19.26 ± 3.51 | 75.96 ± 4.32 | 0.12 ± 0.01 |
| Flaxseed50% Oil | 49.70 ± 0.37 | 1.23 ± 0.20 | 97.53 ± 0.38 | 1.19 ± 0.15 |
| Flaxseed80% Oil | 79.87 ± 0.25 | 16.47 ± 1.05 | 79.39 ± 1.25 | 1.68 ± 0.12 |
| Olive50% Oil | 50.06 ± 0.25 | 1.21 ± 0.37 | 97.58 ± 0.75 | 1.48 ± 0.26 |
| Olive80% Oil | 80.04 ± 0.49 | 20.76 ± 1.58 | 74.06 ± 2.13 | 1.29 ± 0.23 |

sd = standard deviation
meq = milliequivalent

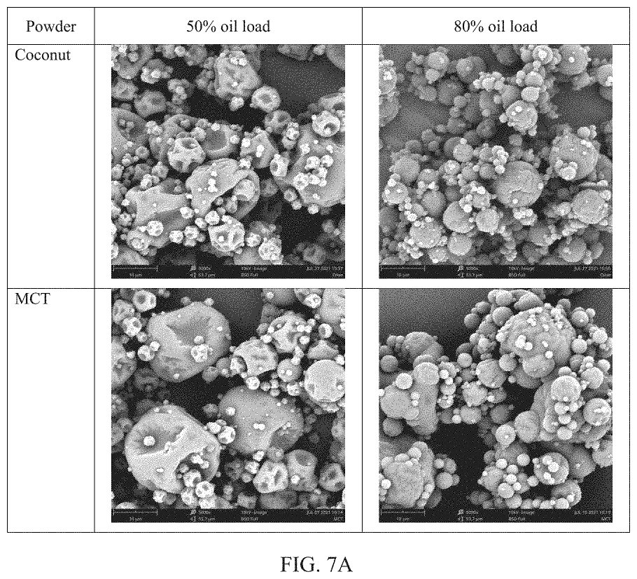

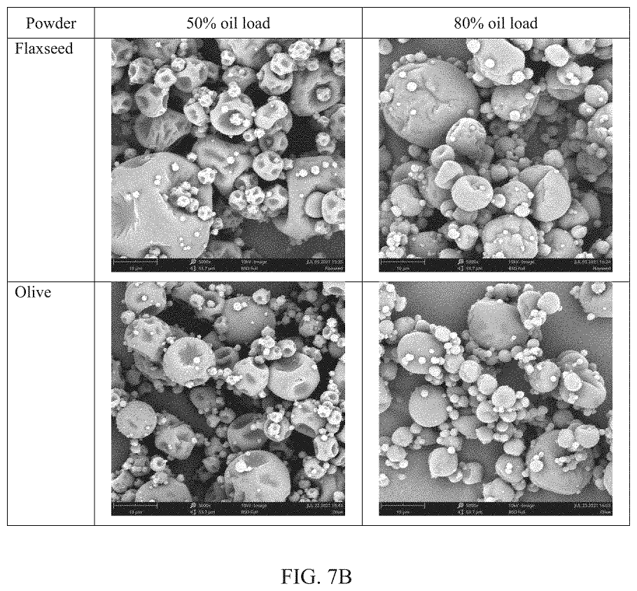

FIGS. 7A and 7B show the SEM images of 50% and 80% oil load of different oil powders. FIG. 7A shows coconut oil and MCT particles, and FIG. 4B shows flaxseed oil and olive oil particles. Primary particles were similar in appearance for all oil types at an equivalent oil load. Differences were observed between 50% and 80% oil load powders, with primary particles in the 80% oil powders showing distinct spherical appearance.

### Example 4

This example demonstrates low temperature electrostatic spray drying of an animal-based oil powder product in an embodiment of the invention.

Fish oil and ghee emulsions were formulated to contain 50% and 80% (w/w) oil, encapsulated with maltodextrin and stabilized with sodium caseinate. Emulsions were then dried using electrostatic spray drying at temperatures of 90° C. inlet and 35° C. outlet. Negative pulsed width modulation (PWM) alternating between 10 kV and 1 kV was used in these examples.

Table 6 shows the moisture content and water activity of the resulting powders. All powders had a moisture content below 3% and a water activity below 0.2 at 50% oil load and less than 0.25 at 80% oil load.

TABLE 6

| | Moisture content solids-non-fat | Water activity (a_{w}) |
|---|---|---|
| Powder | (% w/w ± sd) | (a_{w} ± sd) |
| Fish50% Oil | 1.56 ± 0.04 | 0.139 ± 0.013 |
| Fish80% Oil | 2.08 ± 0.09 | 0.231 ± 0.017 |
| Ghee50% Oil | 1.70 ± 0.23 | 0.192 ± 0.007 |
| Ghee80% Oil | 2.63 ± 0.88 | 0.244 ± 0.057 |

sd = standard deviation

Table 7 shows the oil load, surface free fat, encapsulation efficiency, and peroxide value of the fish oil and ghee powders. At 50% oil load, the surface free fat was approximately 1.1-1.3% and this increased to 17-20% at 80% oil load in all powders. The encapsulation efficiency was >97% at 50% oil load and 74-78% in powders containing 80% oil.

The peroxide values were lowest (0.14-0.31 meq O₂/kg oil) in ghee powders irrespective of oil load presumably due to the high content of saturated fats (Duhan et al., Journal of Food Processing and Preservation, 2021, 45(6), e15537; Gupta et al., Journal of Chemical and Pharmaceutical Research, 2015, 7(1), 568-572). Fish oils are rich in polyunsaturated fatty acids (Hashim et al., Materials Today: Proceedings, 2021, 42, 222-228; Jeyakumari et al., Journal of Food Science and Technology, 2016, 53(1), 856-863), in this case Omega 18/12 (containing 18% eicosapentaenoic acid and 12% docosahexaenoic acid), and therefore the peroxide value increased (1.75 and 3.67 meq O₂/kg oil at 50% and 80% oil load, respectively).

TABLE 7

| | | | Encapsu- | Peroxide |
|---|---|---|---|---|
| | | Surface | lation | value |
| | Oil load | free fat | efficiency | (meq O₂/kg |
| Powder | (% ± sd) | (% ± sd) | (% ± sd) | oil ± sd) |
| Fish50% Oil | 49.78 ± 0.76 | 1.29 ± 0.25 | 97.41 ± 0.54 | 1.75 ± 0.23 |
| Fish80% Oil | 79.69 ± 0.42 | 20.07 ± 2.71 | 74.83 ± 3.27 | 3.67 ± 0.16 |
| Ghee50% Oil | 50.09 ± 0.66 | 1.13 ± 0.15 | 97.75 ± 0.33 | 0.31 ± 0.05 |
| Ghee80% Oil | 80.22 ± 0.47 | 17.88 ± 2.50 | 77.70 ± 3.25 | 0.14 ± 0.02 |

sd = standard deviation
meq = milliequivalent

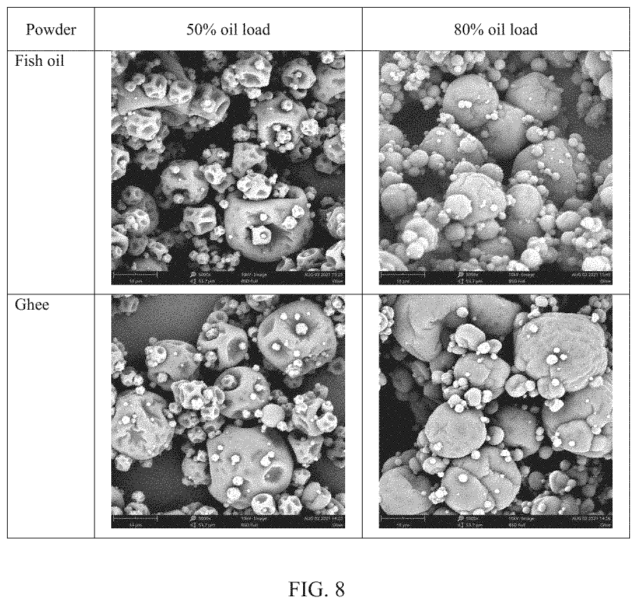

FIG. 8 shows the SEM images of 50% and 80% oil load fish oil and ghee powders. The primary particles were similar in appearance for both oil types at an equivalent oil load. Differences were observed between 50% and 80% oil load powders, with primary particles in the 80% oil powders showing a distinct spherical appearance.

### Example 5

This example demonstrates low temperature electrostatic spray drying of an essential oil powder product in an embodiment of the invention.

Orange and mint oil emulsions were formulated to contain 50% (w/w) oil, encapsulated with maltodextrin and stabilized with sodium caseinate. Emulsions were then dried using electrostatic spray drying at temperatures of 90/35° C. and 150/60° C. inlet and outlet temperatures, respectively. Negative pulsed width modulation (PWM) alternating between 10 kV and 1 kV was used in these examples.

Table 8 shows the water activity of resulting powders. All powders had water activity between 0.1 and 0.23.

TABLE 8

| | Water activity (a_{w}) |
|---|---|
| Powder | (a_{w} ± sd) |
| Orange50% Oil_90/35 | 0.213 ± 0.004 |
| Orange50% Oil_150/60 | 0.100 ± 0.005 |
| Mint50% Oil_90/35 | 0.228 ± 0.003 |
| Mint50% Oil_150/60 | 0.096 ± 0.002 |

sd = standard deviation
90/35, 150/60 = inlet and outlet drying temperatures

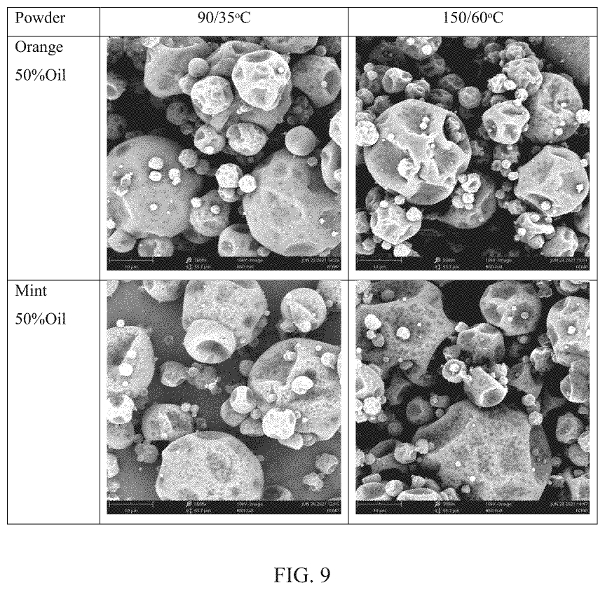

FIG. 9 shows the SEM images of 50% oil load orange and mint powders at two drying temperatures. The primary particles were similar in appearance for both oil types. Differences were observed between orange and mint oil powders, with primary particles in mint oil powders showing more distinct porous surfaces.

### Example 6

This example demonstrates low temperature electrostatic spray drying of an encapsulated oil-bacteria powder product in an embodiment of the invention.

Vegetable oil emulsions were formulated to contain 50% (w/w) oil and 1%, 10% or 20% (w/w) starter culture (S. thermophilus and L bulgaricus mixture). Maltodextrin was the encapsulant, and the emulsion was stabilized with sodium caseinate. Emulsions were dried using electrostatic spray drying at 90° C. inlet and 35° C. outlet. Negative pulsed width modulation (PWM) alternating between 10 kV and 1 kV was used in these examples.

Table 9 shows the moisture content and water activity of resulting powders. All powders had a moisture content below 4% and water activity below 0.25 with 1% and 10% starter culture addition. At 20% culture addition the water activity increase to 0.3.

TABLE 9

| | Moisture content solids-non-fat | Water activity (a_{w}) |
|---|---|---|
| Powder | (% w/w ± sd) | (a_{w} ± sd) |
| 50% Oil_1% Starter | 1.54 ± 0.21 | 0.222 ± 0.006 |
| 50% Oil_10% Starter | 2.01 ± 0.29 | 0.216 ± 0.004 |
| 50% Oil_20% Starter | 3.81 ± 0.24 | 0.299 ± 0.018 |

sd = standard deviation
Starter = starter culture

Table 10 shows the oil load, surface free fat, encapsulation efficiency, and peroxide value for oil-bacteria powders. At 1%, 10%, and 20% culture addition, the surface free fat was less than 1% and the encapsulation efficiency was >98%. The peroxide values were low (<0.2 meq O₂/kg oil).

In a similar study by Eratte et al (Journal of Functional Foods, 2015, 19, 882-892), 50% tuna oil was encapsulated with 16% (w/w) L. casei using whey protein isolate (WPI) and gum Arabic as encapsulants. Emulsions were spray dried at 180 C/80° C. (SD) and freeze-dried (FD). In Eratte et al.'s study, the surface free fat was greater (3.3% by spray drying and 11.3% by freeze drying) than recorded for electrostatic spray drying, and the encapsulation efficiency was lower (93% and 76% for SD and FD, respectively).

TABLE 10

| | | | Encapsu- | Peroxide |
|---|---|---|---|---|
| | | Surface | lation | value |
| | Oil load | free fat | efficiency | (meq O₂/kg |
| Powder | (% ± sd) | (% ± sd) | (% ± sd) | oil ± sd) |
| 50% Oil_1% Starter | 50.25 ± 0.86 | 0.96 ± 0.02 | 98.10 ± 0.07 | 0.19 ± 0.03 |
| 50% Oil_10% Starter | 49.98 ± 0.37 | 0.93 ± 0.04 | 98.22 ± 0.18 | 0.16 ± 0.02 |
| 50% Oil_20% Starter | 49.52 ± 0.98 | 0.79 ± 0.06 | 98.41 ± 0.16 | 0.13 ± 0.02 |

sd = standard deviation
meq = milliequivalent
Starter = starter culture

Bacteria counts (cfu/g) for S. thermophilus (ST) and L. bulgaricus (LB) (<10⁸) at 1-20% (w/w) starter addition are shown in Table 11. In the study by Eratte et al (2015) with 16% (w/w) L. casei addition, viability was <10⁶ after spray drying and <10⁸ after freeze drying. Electrostatic spray drying yields viability data were similar to freeze drying for S. thermophilus and L. bulgaricus at lower addition (1-10% here compared to 16% in Eratte et al. (2015)). At 20% addition of starter culture, the viability of S. thermophilus and L. bulgaricus were 1.82E+07 and 1.04E+09, respectively.

TABLE 11

| | Bacteria counts (cfu/g) | |
|---|---|---|
| Powder | ST | TB |
| 50% Oil_1% Starter | 7.40E+06 | 2.46E+07 |
| 50% Oil_10% Starter | 5.80E+07 | 4.80E+07 |
| 50% Oil_20% Starter | 1.82E+07 | 1.04E+09 |

ST: Streptococcus thermophilus
LB: Lactobacillus bulgaricus

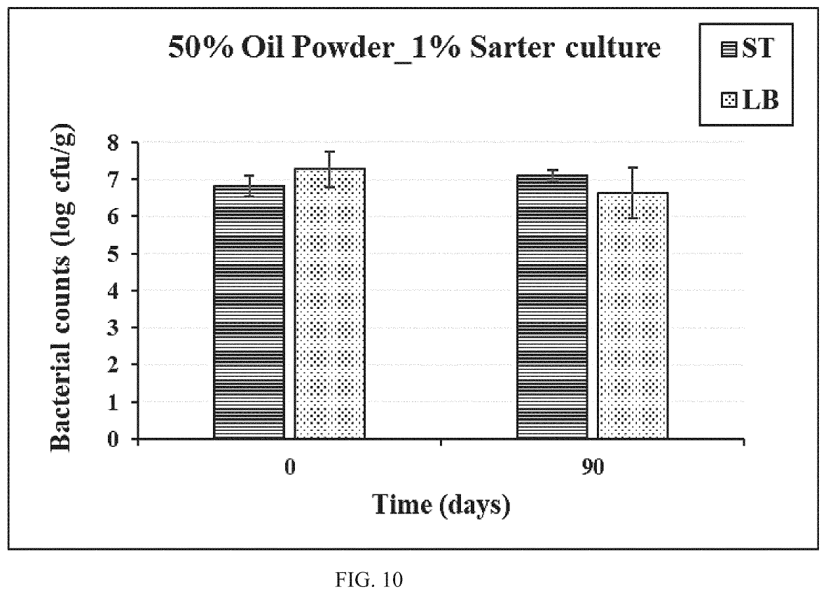

FIG. 10 shows the bacteria counts (log cfu/g, at 1% starter culture addition) for S. thermophilus (ST) and L. bulgaricus (LB) at day 0 and after storage at 4° C. for 90 days. The viability of S. thermophilus and L. bulgaricus remained higher (>7 log cfu/g for ST and >6 log cfu/g for LB) even after 90 days storage.

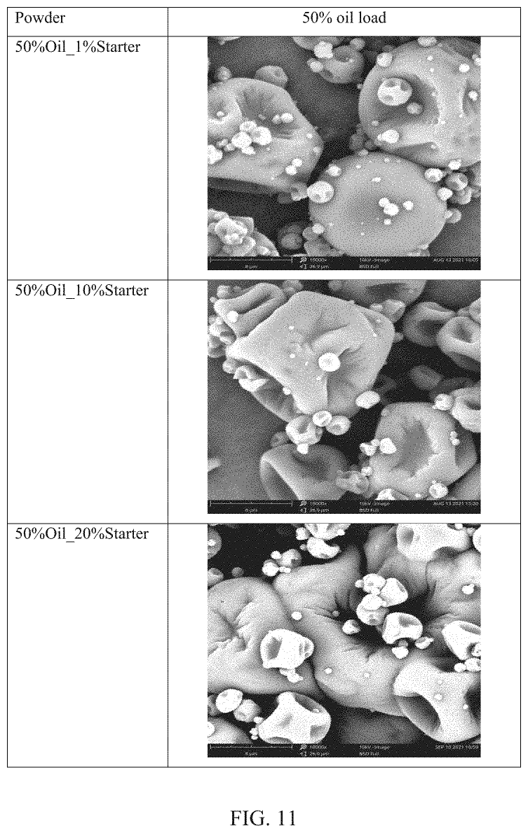

FIG. 11 shows the SEM images of the encapsulated oil-bacteria powders. The primary particles were similar in appearance irrespective of the different loads of starter bacteria.

### Example 7

This example demonstrates low temperature electrostatic spray drying of a docosahexaenoic acid (DHA) oil powder product from microalgae in an embodiment of the invention.

DHA emulsions were formulated to contain 40% (w/w) oil, encapsulated using four different formulations: (i) modified starch, (ii) maltodextrin and casein, (iii) maltodextrin and methylcellulose, and (iv) maltodextrin and saponin (Quilaja). Emulsions were dried using either conventional spray drying (CSD) at an inlet temperature of 120° C., electrostatic spray drying (ESD) at an inlet temperature of 120° C. with negative voltage at 8 kV, or freeze drying (FD).

Table 12 shows the water activity and the encapsulation efficiency. All the powders had a water activity below 0.52, but the ESD powders had a water activity below 0.23. In addition, the peroxide values were measured after 2 months of storage of the resulting powders at 40° C. in the oven using the titration method established by the International Fragrance Association (IFRA) (see, e.g., IFRA Analytical Method, “Determination of the Peroxide Value,” Sep. 10, 20219; and Kaya et al., Food Science and Technology, 141, 110872 (2021)).

TABLE 12

| | | | Peroxide |
|---|---|---|---|
| | | | Value |
| | | | (2 months |
| | Water | Encapsulation | at 40° C.) |
| | activity | Efficiency | (meq O₂/kg |
| Powder | (a_{w}) | (% ± sd) | oil ± sd) |
| CSD - DHA oil + Modified | 0.273 | 99.3 ± 0.3 | 219 ± 2 |
| starch | | | |
| CSD - Maltodextrin + casein | 0.407 | 99.3 ± 0.2 | 682 ± 5 |
| CSD - Maltodextrin + | 0.276 | 31.1 ± 5.9 | 1481 ± 12 |
| methylcellulose | | | |
| CSD - Maltodextrin + Saponin | 0.467 | 19.2 ± 8.0 | 232 ± 2 |
| FD - DHA oil + Modified starch | 0.436 | 98.0 ± 0.3 | 143 ± 1 |
| FD - Maltodextrin + casein | 0.390 | 99.3 ± 0.3 | 501 ± 4 |
| FD - Maltodextrin + | 0.512 | 34.9 ± 7.0 | 1550 ± 12 |
| methylcellulose | | | |
| FD - Maltodextrin + Saponin | 0.453 | 72.4 ± 5.4 | 351 ± 3 |
| ESD - DHA oil + Modified | 0.103 | 99.7 ± 0.1 | 208 ± 4 |
| starch | | | |
| ESD - Maltodextrin + casein | 0.228 | 96.1 ± 0.2 | 444 ± 2 |
| ESD - Maltodextrin + | 0.068 | 31.7 ± 8.2 | 365 ± 3 |
| methylcellulose | | | |
| ESD - Maltodextrin + Saponin | 0.110 | 51.9 ± 2.9 | 160 ± 1 |

sd = standard deviation
meq = milliequivalent
CSD = conventionally spray dried
FD = freeze dried
ESD = electrostatic spray dried

The encapsulation efficiency ranged between 19-100%. The formulation impacted the encapsulation efficiency.

The peroxide values were between 143 to 1550 meq O₂/kg oil after 2 months at 40° C. in the dark.

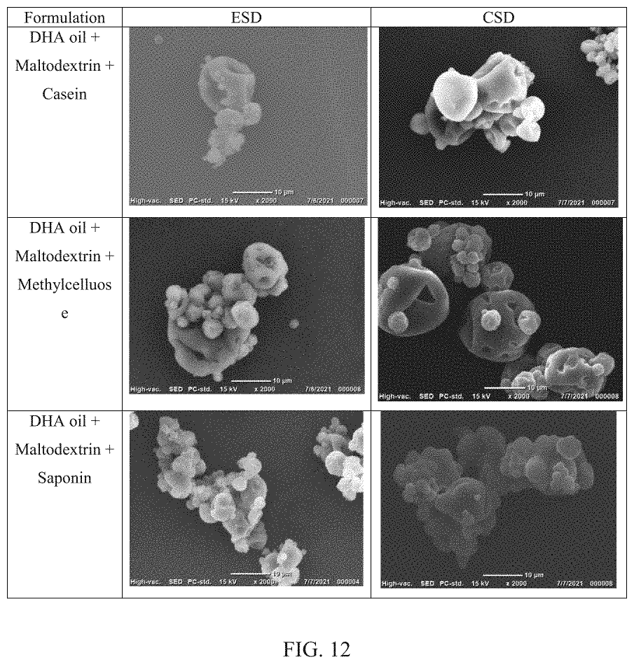

FIG. 12 shows the SEM images of 40% oil load DHA oil CSD and ESD powders with the different formulations. The primary particles were similar in appearance with the same size for all formulation. Differences were observed between the ESD and CSD powders, with a deflated balloon shape more pronounced for ESD than for CSD. The deflated balloon is characteristic of low air inlet and outlet temperatures. This shape also is likely attributed to the fact that the elastic regime is quickly reached during the drying (see, e.g., Sadek et al., Food Hydrocolloids, 48, 8-16 (2015)).

### Example 8

This example compares powder products for encapsulation of oil using an electrostatic spray drying (ESD) system wherein the charge is applied externally to one wherein the charge is applied internally in an embodiment of the invention.

For oil encapsulation applications, the core material can comprise 5% to 90% by weight and the wall material can comprise 10% to 95% by weight of the feedstock solution, based on the total dry weight to the core material and the wall material combined. The feedstock solution may have a viscosity of 1 mPa·s to 10,000 mPa·s, preferably 50 to 250 mPa·s, and the solid content can be between 2 and 75%.

Table 13 shows a formulation of oil encapsulation feedstock used in the present example.

TABLE 13

| | Run 1 | |
|---|---|---|
| | Oil Encapsulation | |
| Feedstock type | kg | % |
| Water | 50 | 50 |
| Capsul TA | 25 | 25 |
| Vegetable oil | 25 | 25 |
| Maltodextrin DE 10 | — | — |
| Maltodextrin DE 18 | — | — |
| Total Mass | 100 | 100 |
| Total Solids | 50 | 50 |

Capsul TA is a modified food starch derived from tapioca (Ingredion, Westchester, Ill., USA) used as the encapsulation agent instead of maltodextrin. Capsul TA and water were mixed 12 hours before adding to oil, then the total mixture was homogenized for 30 min at 3600 RPM.

Table 14 shows set up of Fluid Air PolarDry® system Model 032 electrostatic spray dryer (Spraying Systems, Naperville, Ill., USA) used in the example.

TABLE 14

| | Run 1a | Run 1b |
|---|---|---|
| Nozzle Set-up | Single, Internal | Single, External |
| | negative | positive |
| | charge | charge |
| Fluid Tip | 0.1″ | 0.1″ |
| Pump Tubing ID | 12.7 mm, with | 12.7 mm, with |
| | recirculation | recirculation |
| Chamber Vane/Baffle | Installed | Installed |
| Filters | High Pleat | High Pleat |

In encapsulation of oil with an ESD system having an external charge applied, the system parameters are generally similar to those used for an ESD system with an internal charge, except that lower voltages can be applied. For example, a constant charge between 0.1 kV and 0.5 kV, or a pulsed charge alternating between 0 and 5 kV, can be used with an atomizing gas to create droplets in an inert drying gas. The charge can be positive or negative. The pressure of the atomizing gas can be between 0.2 to 6 bars. The inlet drying gas temperature can be between 40 to 150° C. The inert gas flowrate is between 2 to 20 000 Nm³/h.

Table 15 shows the operating parameters of the ESD used in the present example.

TABLE 15

| | Run 1 a | Run 1 b |
|---|---|---|
| Drying Gas Flow (Nm³/h) | 1000 | 1000 |
| Inlet Temperature (° C.) | 140 | 140 |
| Atomizing pressure (kPa) | 350 | 350 |
| Atomizing gas temp (° C.) | 90 | 90 |
| Speed pump (lbs/h) | 30 -> 64 | 20 -> 48 -> 40 |
| Estimated Feed Rate (kg/h) | 3 -> 65 | 30 |
| Voltage (kV) | 22.5 | 1.75 |
| Outlet Temperature (° C.) | 113 -> 78.1 | 115 -> 92.8 |

Table 16 shows the size distributions of the particles produced in runs 1a (internal charge) and 1b (external charge), determined using a Malvern Panalytical MasterSizer 3000 instrument with an Aero S or Hydro EV accessory (Spectris plc, London, UK).

TABLE 16

| | Run 1a | Run 1b |
|---|---|---|
| Dv (10) (μm) | 26 | 49 |
| Dv (50) (μm) | 104 | 193 |
| Dv (90) (μm) | 255 | 681 |

Run 1b resulted in larger particle agglomerations at every point along the particle size distribution than Run 1a did. In general, the more aggregated the powder, the better the wettability of the powder, partly due to decreased surface area leading to reduced percentage of oil at the surface. Wettability (i.e., capacity of powder particles to absorb water on their surface) can be measured by any suitable method, such as IDF (1979) (“Determination of the dispersibility and wettability of instant dried milk.” IDF Standard No. 87. International Dairy Federation, Brussels) and GEA Niro Method No. A 6 a (revised 2005).

Table 17 shows the moisture content of the powders produced in Runs 1a and 1b, determined using a thermobalance (Sartorius MA37, Sartorius AG, Gottingen, Germany) at a temperature of 110° C. with 1-2 g of sample powder.

TABLE 17

| | % moisture |
|---|---|
| | content |
| Run 1a | |
| (internal charge) | |
| 25 LPH | 1.9 |
| 28 LPH | 1.98 |
| 32 LPH | 1.35 |
| 36 LPH | 1.77 |
| 40 LPH | 2.8 |
| 44 LPH | 2.59 |
| 52 LPH | 2.6 |
| 56 LPH | 2.64 |
| 60 LPH | 3.61 |
| 64 LPH | 6.14 |
| Run 1b | |
| (external charge) | |
| 40 LPH | 2.23 |

For oil encapsulation, the moisture content of the final powder has to be below 5%. For run 1a, with a feedstock of 50% solid content, the maximum feed rate that results in a moisture content <5% is 56-60 LPH, i.e., 56-60 kg/h. There is no noticeable difference between the moisture content of samples prepared with internal charge and those prepared with external charge, e.g., at a flow rate of 40 LPH, the moisture content of Run 1a was 2.8 and that of Run 1b was 2.23.

Table 18 shows the surface oil content and oil encapsulation efficiency of powders produced with the ESD spray dryer system having either internal or external charge nozzles, compared to the values for a powder produced by a conventional high temperature spray dryer, the Buchi B290 (Buchi, Switzerland).

TABLE 18

| | % | Encapsulation | % oil |
|---|---|---|---|
| | surface oil | Efficiency (%) | inside |
| 40 LPH | 11.1 | 94 | 83.00 |
| (Run 1a, internal charge) | | | |
| 40 LPH | 11.2 | 103 | 83.00 |
| (Run 1b, external charge) | | | |
| Buchi | 1.6 | 80 | 77.96 |

The surface oil content of sample prepared with the ESD system was essentially the same with both the internal and external charge nozzles, and both values were greater than for the comparative Buchi spray dryer. However, the oil encapsulation efficiency was substantially improved in the ESD system of the present invention, with the oil encapsulation efficiency being essentially 100% for the ESD system with the nozzle applying the charge externally.

### Example 9

This example compares encapsulated bacteria powder products prepared using an electrostatic spray drying (ESD) system wherein the charge is applied externally to one wherein the charge is applied internally in an embodiment of the invention.

Table 19 shows a formulation of bacteria encapsulation feedstock used in the present example.

TABLE 19

| | Run | |
|---|---|---|
| | Bacteria Encapsulation | |
| Feedstock type | kg | % |
| Water | 73.6 | 73.6 |
| Maltodextrin DE19 | 25 | 25 |
| Bacteria LGG | 1.4 | 1.4 |
| Total Mass | 100 | 100 |
| Total Solids | 26.4 | 26.4 |

This example used Lactobacillus Rhamnosus (LGG) from CHR Hanssen. For the laboratory scale experiemnt, 1.4 g of LGG was added to a solution of maltodextrin DE19 (20% dry weight) (Glucidex® 19, Roquette). 400 g of solution was dried at laboratory scale for SD, FD and ESD. At industrial scale, the feedstock quantity was adjusted regarding evaporation capacities of each technology and expected yield.

Table 20 shows set up of Fluid Air PolarDryJ system Models 001 and 032 electrostatic spray dryer used in the example. Model 001 is a lab-scale spray dryer system, while Model 032 is a larger, pilot-scale system.

TABLE 20

| | Single, Internal | Single, External |
|---|---|---|
| Nozzle Set-up | negative charge | positive charge |
| Fluid Tip | 0.04″ | 0.1″ |
| Pump Tubing ID | 0.6 mm, without | 12.7 mm, with |
| | recirculation | recirculation |
| Chamber Vane/Baffle | None | Installed |
| Filters | Cartridge 3 μm | High Pleat |

Table 21 shows the operating conditions of Models 001 and 032 electrostatic spray dryers used in the example.

TABLE 21

| | Run 001 | Run 032 |
|---|---|---|
| Drying Gas Flow (Nm³/h) | 25 | 25 |
| Inlet Temperature (° C.) | 80 | 80 |
| Atomizing pressure (kPa) | 300 | 300 |
| Atomizing gas temp (° C.) | 25 | 25 |
| Estimated Feed Rate (kg/h) | 0.3 | 12 |
| Voltage (kV) | 8 | 3 |
| Outlet Temperature (° C.) | 39 | 49 |

Table 22 shows the operating conditions of the Cryotec Pilote bench model (Saint-Gély-du-Fesc, France) freeze dryer used in the example.

TABLE 22

| FD | Steps | Time (h) | Temperature (° C.) | Pressure (mBar) |
|---|---|---|---|---|
| | Freezing | 48 | −85 | 0.37 |

Table 23 shows the water activity of the dried powders, determined using Rotronic equipment.

TABLE 23

| | Water activity |
|---|---|
| Powder | (a_{w}) |
| Run Model 001 | 0.13 |
| Run Model 032 | 0.28 |
| Freeze Dried | 0.03 |

All the powders had a water activity below 0.28.

The bacteria powders were analysed for content of viable cells using the following method: 1 g of powder was resuspended in 10 mL of TS buffer; an appropriate serial dilution was made; and 1 mL of each final solution was placed onto an MRS agar plate. The percentage of cell survival was defined as the ratio between log (CFU/g) of viable cells, before and after drying. To assess stability over time, the same measurements were done at different time over 2 months.

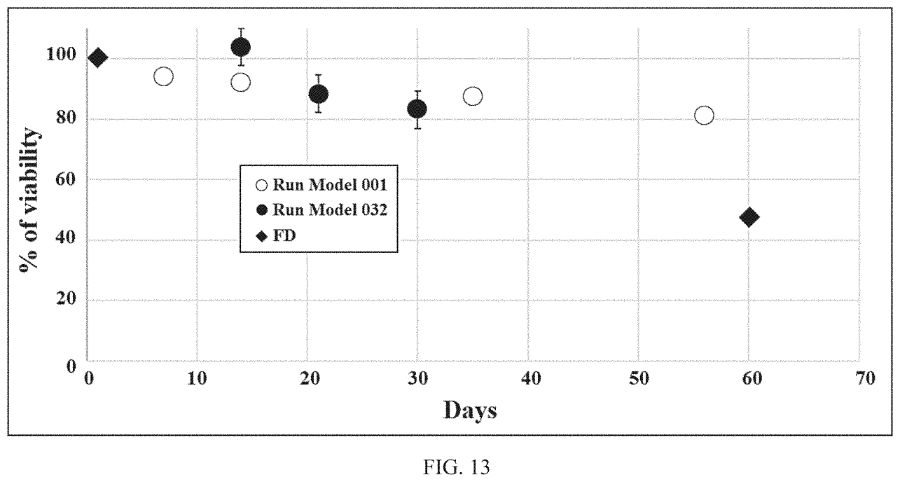

FIG. 13 shows a graph depicting the relationship between percentage of viable bacterial cells in the dried powders versus time (in days), after drying with: electrostatic spray drying with an internal negative charge system (Run Model 001), with an external positive charge system (Run Model 032), and with conventional freeze drying. The results show that the electrostatic spray dried powders exhibited similar stability to the freeze dried powder, and may be more stable after an extended time, i.e., around 2 months. Even though the outlet temperature was 10° C. higher during the spray drying with the external charge in the Model 032 system, when compared to the conditions for spray drying with an internal charge in the Model 001 system, the oil-bacterial powders exhibited similar stability with time.

### Example 10

This example compares the effects of external vs. internal applied charge and different inlet temperature on the encapsulation efficiency of volatile oil (Peppermint oil) in an embodiment of the invention.

Table 24 shows a formulation of oil Peppermint oil encapsulation feedstock used in the present example.

TABLE 24

| | 15% of solid content; | |
|---|---|---|
| | Ingredients | Ingredients |
| Feedstock Formulation | (%) Wet Basis | (%) Dry Basis |
| Essential Oil—Peppermint | 15 | |
| Capsul TA | 15 | 15 |
| Water | 70 | — |
| Total | 100 | 15 |

Capsul TA was hydrated overnight, then combined with the peppermint oil and homogenized for 30 min.

Table 25 shows set up of Fluid Air PolarDry® system Model 032 electrostatic spray dryer (Spraying Systems, Naperville, Ill., USA) used all runs of the example.

TABLE 25
Electrostatic Spray Dry

| Run Number | 1 | 2 | 3 | 4 |
|---|---|---|---|---|
| Feedstock | Standard | Standard | Standard | Standard |
| Container | Tank | Tank | Tank | Tank |
| Conveyor | Yes | Yes | Yes | Yes |
| Filters | High pleat | High pleat | High pleat | High pleat |
| Nozzle—Type | 0.050″ | 0.050″ | 0.050″ | 0.050″ |
| and Size | | | | |
| Nozzle—Charge | Internal, | Internal, | External, | External, |
| | negative | negative | positive | positive |
| Pump Tubing | 12.7 mm | 12.7 mm | 12.7 mm | 12.7 mm |
| Flow Bypass | Yes | Yes | Yes | Yes |
| (Yes or No) | | | | |

Table 26 shows the operating conditions of Model 032 electrostatic spray dryer used in the example.

TABLE 26

| Run Number | 1 | 2 | 3 | 4 |
|---|---|---|---|---|
| Drying Gas Flow | 1000 | 1000 | 1000 | 1000 |
| (Nm³/hr) | | | | |
| Inlet Drying Gas | 140 | 90 | 140 | 90 |
| Temp ° C. | | | | |
| Atomizing Gas | 250 | 250 | 250 | 250 |
| Pressure (kPa) | | | | |
| Atomizing Gas | 80 | 80 | 80 | 80 |
| Temp ° C. | | | | |
| Pump Flow (LPH) | 19 kg/h | 10 kg/h | 19 kg/h | 10 kg/h |
| Pump Mode: Speed | Speed | Speed | Speed | Speed |
| vs Flow | | | | |
| Voltage High (kV) | 15 | 15 | 3 | 3 |

Table 27 shows the water activity of the dried bacteria powders, determined using Rotronic equipment.

TABLE 27

| Run Number | 1 | 2 | 3 | 4 |
|---|---|---|---|---|
| Water activity | 0.0651 | 0.080 | 0.080 | 0.094 |

All the powders had a very low water activity, below 0.094, assuring the vitality of the encapsulated bacteria.

Table 28 shows the oil encapsulation efficiency of volatile oil powders produced with the ESD spray dryer system having either internal or external charge nozzles, and at relatively higher (140° C.) and lower (90° C.) inlet temperatures. To determine the encapsulation efficiency, 1 g of powder was added to 9 g of water, and the solution was allowed to evaporate in a 130° C. oven for 60 hrs. Calculation of the percentage of oil in the powder was made with the assumption that the moisture content was 5%, and was calculated as:

$$Encapsulation Efficiency of volatiles = \frac{quantity of evaporated oil in the powder}{quantity of initial evaporated oil in the solution}$$

TABLE 28

| Run Number | 1 | 2 | 3 | 4 |
|---|---|---|---|---|
| Encapsulation | 53.1 | 68.1 | 50.3 | 67.5 |
| efficiency (%) | | | | |

The data show that ESD system with external charge at low voltage (3 V) has the same encapsulation efficiency as ESD system with internal charge and high voltage (15V), at both low and high inlet temperatures. However, the data also show that a lower inlet temperature (runs 2 and 4) result in greater encapsulation efficiency than a higher inlet temperature (runs 1 and 3).

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of providing an active compound powder comprising electrostatic spray drying a formulation comprising at least one active compound, an encapsulating agent, and optionally an excipient at an inlet temperature of 150° C. or below and an exhaust temperature of 100° C. or below, wherein electrical charge is applied externally to droplets of active compound formulation feedstock liquid.

2. The method of claim 1, wherein the atomizing temperature is about 100° C. or below.

3. The method of claim 1, wherein the applied voltage is about 0.1 kV or more.

4. The method of claim 1, wherein the applied voltage is continuous.

5. The method of claim 1, wherein the applied voltage is modulated between two or more different voltages.

6. The method of claim 1, wherein the at least one active compound is an antioxidant, a vitamin, a bacterium, an omega oil, an essential oil, a flavoring agent, a pigment, a dye, or a combination thereof.

7. The method of claim 1, wherein when the active compound is an oil the optional excipient is an emulsifier, and when the active compound is other than an oil the optional excipient is an oil.

8. The method of claim 7, wherein the oil is plant or animal in origin.

9. The method of claim 8, wherein the at oil is vegetable oil, vegetable shortening, castor oil, rice brain oil, olive oil, canola oil, corn oil, palm oil, coconut oil, flaxseed oil, hempseed oil, rapeseed oil, linseed oil, grapeseed oil, rosehip seed oil, pomegranate seed oil, watermelon seed oil, seabuckthorn berry oil, camellia seed oil (tea oil), cranberry seed oil, hemp seed oil, borage seed oil, evening primrose oil, argan oil, jojoba oil, marula oil, carrot oil, sesame seed oil, sunflower oil, shea nut oil, soybean oil, peanut oil, walnut oil, almond oil, hazelnut oil, kukui nut oil, pecan oil, macadamia nut oil, meadowfoam oil, avocado oil, apricot kernel oil, an essential oil, silicone oil, fish oil, cocoa butter, shea butter, butter, ghee, medium chain triglycercides (MCT), or any combination thereof.

10. The method of any claim 1, wherein the encapsulating agent is a carbohydrate, a lipid, a protein, ascorbic acid, or a combination thereof.

11. The method of claim 13, wherein the carbohydrate is maltodextrin, sucrose, dextrose, glucose, lactose, trehalose, amylase, cyclodextrin, dextrin, galactomannan, pectin, starch, modified food starch, inulin, gum Arabic, guar gum, gellan gum, mesquite gum, xanthan gum, alginate, chitosan, shellac, carboxymethylcellulose, or a combination thereof.

12. The method of claim of 10, wherein the lipid is a fatty acid or an ester thereof, a fatty alcohol or an ester thereof, a triglyceride, a phospholipid, a glycolipid, an aminolipid, a lipopeptide, partial acylglycerol, or a combination thereof.

13. The method of claim 10, wherein the protein is casein, caseinate, gelatin, casein, soy protein, wheat protein, whey protein, rice protein, pea protein, cocoa shell protein, or a combination thereof.

14. A method of providing an oil emulsion powder comprising electrostatic spray drying an emulsion comprising at least one oil, an encapsulating agent, and optionally an emulsifier at an inlet temperature of 150° C. or below and an exhaust temperature of 100° C. or below, wherein electrical charge is applied externally to droplets of oil emulsion feedstock liquid.

15. The method of claim 14, wherein the atomizing temperature is about 100° C. or below.

16. The method of claim 14, wherein the applied voltage is about 0.1 kV or more.

17. The method of claim 14, wherein the applied voltage is continuous.

18. The method of claim 14, wherein the applied voltage is modulated between two or more different voltages.

19. The method of claim 14, wherein the oil emulsion powder has lower amount of surface free fat compared to a spray dried powder of the same oil emulsion.

20. The method of claim 14, wherein the oil emulsion powder has an encapsulation efficiency of 50% or more.

21. The method of claim 20, wherein the oil load ranges from 1-60% and the encapsulation efficiency ranges from 90-99%.

22. The method of claim 20, wherein the oil load ranges from 61-90% and the encapsulation efficiency ranges from 55-90%.

23. The method of claim 14, wherein the at least one oil is plant or animal in origin.

24. The method of claim 23, wherein the at least one oil is vegetable oil, vegetable shortening, castor oil, rice brain oil, olive oil, canola oil, corn oil, palm oil, coconut oil, flaxseed oil, hempseed oil, rapeseed oil, linseed oil, grapeseed oil, rosehip seed oil, pomegranate seed oil, watermelon seed oil, seabuckthorn berry oil, camellia seed oil (tea oil), cranberry seed oil, hemp seed oil, borage seed oil, evening primrose oil, argan oil, jojoba oil, marula oil, carrot oil, sesame seed oil, sunflower oil, shea nut oil, soybean oil, peanut oil, walnut oil, almond oil, hazelnut oil, kukui nut oil, pecan oil, macadamia nut oil, meadowfoam oil, avocado oil, apricot kernel oil, an essential oil, silicone oil, fish oil, cocoa butter, shea butter, butter, ghee, medium chain triglycercides (MCT), or any combination thereof.

25. The method of claim 14, wherein the encapsulating agent is a carbohydrate, a lipid, a protein, ascorbic acid, or a combination thereof.

26. The method of claim 25, wherein the carbohydrate is maltodextrin, sucrose, dextrose, glucose, lactose, trehalose, amylase, cyclodextrin, dextrin, galactomannan, pectin, starch, modified food starch, inulin, gum Arabic, guar gum, gellan gum, mesquite gum, xanthan gum, alginate, chitosan, shellac, carboxymethylcellulose, or a combination thereof.

27. The method of claim of 25, wherein the lipid is a fatty acid or an ester thereof, a fatty alcohol or an ester thereof, a triglyceride, a phospholipid, a glycolipid, an aminolipid, a lipopeptide, partial acylglycerol, or a combination thereof.

28. The method of claim 25, wherein the protein is casein, caseinate, gelatin, casein, soy protein, wheat protein, whey protein, rice protein, pea protein, cocoa shell protein, or a combination thereof.

29. The method of claim 14, wherein the emulsion comprises an emulsifier.

30. The method of claim 29, wherein the emulsifier is at least one selected from casein, caseinate, lecithin, saponin, carrageenan, gum Arabic, xanthan, whey protein isolate, stearate, glyceryl monostearate, sucrose ester, monopropylene glycol, propylene glycol ester of fatty acid, polyglycerol esters of fatty acid, a mono- and diglycerol, mono- and diglycerides of fatty acids, distilled monoglyceride, polyglycerol polyricinoleate, polysorbate 80, a sorbitan ester, a lactylated ester, an ethoxylated ester, a succinated ester, a fruit acid ester, carboxymethyl cellulose, and a combination thereof.

31. The method of claim 14, wherein the emulsion further comprises at least one active compound.

32. The method of claim 31, wherein the at least one active compound is an antioxidant, a vitamin, a bacterium, an omega oil, an essential oil, a flavoring agent, a pigment, a dye, or a combination thereof.
